(19) United States
(12) Patent Application Publication
(10) Pub. No.: US 2025/0266506 A1
(43) Pub. Date: Aug. 21, 2025

(54) INTERLAYER FOR SOLID-STATE BATTERY HAVING A LITHIUM ELECTRODE

(71) Applicant: CORNING INCORPORATED, CORNING, NY (US)

(72) Inventors: Michael Edward Badding, Campbell, NY (US); Qixin Liang, Suzhou (CN); Jianmeng Su, Shanghai (CN); Yan Wang, Horseheads, NY (US); Tongping Xiu, Shanghai (CN)

(21) Appl. No.: 18/976,853

(22) Filed: Dec. 11, 2024

(30) Foreign Application Priority Data
Feb. 18, 2024 (CN) 202410182960.8

(51) Int. Cl. H01M 10/42; H01M 4/04; H01M 10/0562; H01M 10/058

(52) U.S. Cl. CPC H01M 10/4235; H01M 4/0407; H01M 10/0562; H01M 10/058; H01M 2300/0071

(57) ABSTRACT

A solid-state battery having a solid electrolyte, an anode configured to contain lithium when the solid-state battery is in a charged state, a magnesium layer positioned adjacent to the anode and between the anode and the solid electrolyte, and at least one metal layer positioned adjacent to the magnesium layer and between the magnesium layer and the solid electrolyte.

### CROSS REFERENCE TO RELATED APPLICATIONS

This application claims the benefit of Chinese Patent Application Serial No. 202410182960.8, filed Feb. 18, 2024, the entirety of which is incorporated herein by reference for all purposes.

### BACKGROUND

Solid-state batteries using lithium metal anodes and solid electrolytes, especially the high ionic conductivities and chemical stability garnet-type oxide electrolytes (such as Li₇La₃Zr₂O₁₂ (LLZO)), are considered promising alternatives to the current lithium-ion batteries because they are safe and can potentially exhibit high energy densities. However, their practical implementation has been impeded by the inferior interfacial contact and stability between lithium metal electrodes and solid electrolytes due to the rigid solid-solid interface, poor wettability, and brittleness of the garnet electrolyte. Thus, there remains a need in the art for improved solid-state batteries.

### BRIEF SUMMARY

Disclosed herein is an arrangement of magnesium-containing multilayer composite interlayer and method of making.

According to embodiments, a solid-state battery comprises: a solid electrolyte; an anode configured to contain lithium when the solid-state battery is in a charged state; a magnesium layer positioned adjacent to the anode and between the anode and the solid electrolyte; and at least one metal layer positioned adjacent to the magnesium layer and between the magnesium layer and the solid electrolyte.

Another embodiment, a consumer electronic product comprises: a housing having a front surface, a back surface and side surfaces; electrical components at least partially within the housing, the electrical components including at least a controller, a memory, and a display; and a solid-state battery as disclosed and described herein within the housing.

Embodiments also include a method for making a solid-state battery disclosed and described herein comprising, in any order: providing a solid electrolyte; depositing the at least one metal layer onto the solid electrolyte; depositing the magnesium layer onto the at least one metal layer; and applying the anode to the magnesium layer.

### BRIEF DESCRIPTION OF THE DRAWINGS

To easily identify the discussion of any particular element or act, the most significant digit or digits in a reference number refer to the figure number in which that element is first introduced.

FIG. 1 is a schematic of a cross section of half a battery cell having a single metal layer according to embodiments disclosed and described herein;

FIG. 2 is a schematic of a cross section of half a battery cell having two metal layers according to embodiments disclosed and described herein;

FIG. 3 is a schematic of a cross section of an asymmetric battery cell having a single metal layer and a second electrode on the solid electrolyte according to embodiments disclosed and described herein;

FIG. 4 is a schematic of a cross section of a symmetric battery cell having a single metal layer on each side of the solid electrolyte according to embodiments disclosed and described herein;

FIG. 5 is a schematic of a cross section of a symmetric battery cell having a two metal layers on each side of the solid electrolyte according to embodiments disclosed and described herein;

FIG. 6A is a Nyquist plot of real impedance (−Z′, Ω cm²) versus imaginary impedance (Z″, Ω cm²), showing impedance measurement results of the symmetric cells prepared in Example 1 and Comparable Example 1 to 4 that have not been heat treated;

FIG. 6B is a Nyquist plot of real impedance (−Z′, Ω cm²) versus imaginary impedance (Z″, Ω cm²), showing impedance measurement results of the symmetric cells prepared in Example 1 and Comparable Example 1 to 4 that after heat treatment;

FIG. 7A is a graph of voltage (V vs. Li/Li⁺) versus cycling time (hours), showing the voltage profile and critical current density of the symmetric cell prepared in Example 1 according to embodiments disclosed and described herein

FIG. 7B is a graph of voltage (V vs. Li/Li⁺) versus cycling time (hours), showing the voltage profile and critical current density of the symmetric cell prepared in Comparative Example 1;

FIG. 7C is a graph of voltage (V vs. Li/Li⁺) versus cycling time (hours), showing the voltage profile and critical current density of the symmetric cell prepared in Comparative Example 2;

FIG. 7D is a graph of voltage (V vs. Li/Li⁺) versus cycling time (hours), showing the voltage profile and critical current density of the symmetric cell prepared in Comparative Example 3;

FIG. 7E is a graph of voltage (V vs. Li/Li⁺) versus cycling time (hours), showing the voltage profile and critical current density of the symmetric cell prepared in Comparative Example 4;

FIG. 8A is a graph of voltage (V vs. Li/Li⁺) versus areal capacity (mAh/cm²), showing charge and discharge voltage profile and the charging CCD of a solid-state full cells prepared in Example 2 according to embodiments disclosed and described herein.

FIG. 8B is a graph of voltage (V vs. Li/Li⁺) versus areal capacity (mAh/cm²), showing charge and discharge voltage profile and the charging CCD of a solid-state full cells prepared in Comparative Example 5;

FIG. 8C is a graph of voltage (V vs. Li/Li⁺) versus areal capacity (mAh/cm²), showing charge and discharge voltage profile and the charging CCD of a solid-state full cells prepared in Example 3 according to embodiments disclosed and described herein.

FIG. 8D is a graph of voltage (V vs. Li/Li⁺) versus areal capacity (mAh/cm²), showing charge and discharge voltage profile and the charging CCD of a solid-state full cells prepared in Comparative Example 6;

FIG. 8E is a graph of voltage (V vs. Li/Li⁺) versus areal capacity (mAh/cm²), showing charge and discharge voltage profile and the charging CCD of a solid-state full cells prepared in Example 4 according to embodiments disclosed and described herein.

### DETAILED DESCRIPTION

To alleviate interfacial contact issues between lithium metal electrodes and solid electrolytes, many efforts have been made, one of which is to introduce Li-alloy as an anode. It is reported that magnesium is introduced in the form of Li—Mg alloy as substitution of pure Li metal anode owing to higher Li diffusion coefficient in the Li—Mg alloy and Mg framework that will maintain Li intercalation/extraction cycling life. However, there remains a need to form more efficient and long-lasting solid-state batteries.

One side effect to the Li/garnet interfacial resistance and cell performance has been noticed when Mg is directly deposited on the garnet surface via sputtering, which is likely due to side reaction of the garnet take place during deposition.

Herein, a new arrangement of magnesium-containing multilayer composite interlayer is provided. In embodiments, solid-state batteries with these interlayers exhibited a negligible Li/garnet interfacial resistance with a value less than 0.2 Ω cm² at room temperature. In embodiments, the corresponding symmetric cells delivered a critical current density with a value of 2.4 mA/cm².

In embodiments, a solid-state battery comprises a solid electrolyte, an anode configured to contain lithium when the solid-state battery is in a charged state, a magnesium layer positioned adjacent to the anode and between the anode and the solid electrolyte, and at least one metal layer positioned adjacent to the magnesium layer and between the magnesium layer and the solid electrolyte. Solid-state batteries having the structures outlined herein, in embodiments, provide a negligible Li/garnet interfacial resistance with a value less than 0.2 Ω cm² at room temperature. In embodiments, the corresponding symmetric cells delivered a critical current density with a value of 2.4 mA/cm².

As noted herein above, it has been found that interfacial contact and stability issues exist when lithium-containing electrodes are deposited on solid electrolytes, such as LLZO for example. This can lead to poor performance of a solid-state battery using these components. One way that these interfacial contact and stability issues have been addressed is by using an alloy of lithium and magnesium as an electrode. However, interfacial resistance and poor cell performance has been noticed when a magnesium-containing layer is deposited on a solid electrolyte, which is likely due to side reactions of the solid electrolyte and the magnesium-containing material during sputtering. As noted above, embodiments disclosed and described herein address the poor performance of lithium solid-state batteries by providing a composite interlayer between the lithium electrode and the solid electrolyte, where the composite layer comprising a magnesium layer and at least one metal layer.

It should be understood that although the various layers of solid-state batteries disclosed and described herein are referred to by their components (such as “magnesium layer” and “metal layer”), the layers may not be one hundred percent pure layers. The various layers may contain impurities common in manufacturing, for example. Moreover, as the solid-state batteries are charged and discharged ions, particularly lithium ions, move through the solid-state battery from the anode to the cathode and vice versa. Thus, at various states of charge and discharge the layers will contain ions, such as lithium ions.

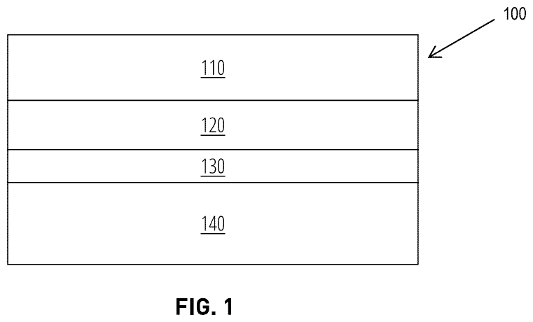

With reference now to FIG. 1, a cross-section view of an asymmetric solid-state cell 100 according to embodiments disclosed and described herein is provided. The asymmetric solid-state cell 100 includes an anode 110 that is configured to contain lithium when the asymmetric solid-state cell 100 is in a charged state. Adjacent to the anode 110 is a magnesium layer 120. It should be understood that the magnesium layer 120 may be physically or electrically connected to the anode 110 such that lithium ions can transition from the anode 110 to the magnesium layer 120. This magnesium layer 120 can promote increased lithium diffusion and improve the intercalation/extraction cycling life of the asymmetric solid-state cell 100. At least one metal layer 130 is positioned adjacent to the magnesium layer 120 such that lithium ions can transition from the magnesium layer 120 to the at least one metal layer 130. A solid electrolyte 140 is positioned adjacent to at least one metal layer 130. The solid electrolyte 140 may be physically or electrically connected to the at least one metal layer 130 such that lithium ions can transition from the at least one metal layer 130 to the solid electrolyte 140. The at least one metal layer 130 is believed to improve the interfacial contact to the solid electrolyte 140, thereby decreasing the resistance between the solid electrolyte 140 and the anode 110 compared to a solid-state cell where a magnesium layer is adjacent to the solid electrolyte. Although only one metal layer is depicted in FIG. 1, it is contemplated that the at least one metal layer 130 (in any FIG. herein and in any embodiment herein) can include any suitable number of layers, including two, three, four, five, six, seven, eight, nine, or ten metal layers, each of which can be the same or different.

The anode 110 may be made from lithium or any lithium-based material suitable for use in a lithium-based solid-state battery. It should be understood that the anode 110 initially comprises lithium when the solid-state battery is in a charged state, but, as the battery discharges, the lithium transitions from the anode 110 through the magnesium layer 120 and the at least one metal layer 130 to the solid electrolyte 140. However, when the solid-state battery is charged, the lithium ions transition back from the solid electrolyte 140 through the at least one metal layer 130 and magnesium layer 120 to the anode 110. Thus, the anode 110 is configured to comprise lithium ions when the solid-state battery is in a charged state, but the anode 110 may comprise little or no lithium ions when the solid-state battery is in a discharged state.

The anode 110 may be applied to the magnesium layer 120 by attaching (pressing, melting and depositing, such as PVD, electrochemical precipitation) lithium or lithium-containing foils to the magnesium layer 120. In embodiments, the anode 110 has a thickness that is greater than 0 μm and less than or equal to 100 μm, such as greater than or equal to 10 μm and less than or equal to 100 μm, greater than or equal to 25 μm and less than or equal to 100 μm, greater than or equal to 40 μm and less than or equal to 100 μm, greater than or equal to 50 μm and less than or equal to 100 μm, greater than or equal to 60 μm and less than or equal to 100 μm, greater than or equal to 75 μm and less than or equal to 100 μm, greater than or equal to 90 μm and less than or equal to 100 μm, greater than 0 μm and less than or equal to 90 μm, greater than or equal to 10 μm and less than or equal to 90 μm, greater than or equal to 25 μm and less than or equal to 90 μm, greater than or equal to 40 μm and less than or equal to 90 μm, greater than or equal to 50 μm and less than or equal to 90 μm, greater than or equal to 60 μm and less than or equal to 90 μm, greater than or equal to 75 μm and less than or equal to 90 μm, greater than 0 μm and less than or equal to 75 μm, greater than or equal to 10 μm and less than or equal to 75 μm, greater than or equal to 25 μm and less than or equal to 75 μm, greater than or equal to 40 μm and less than or equal to 75 μm, greater than or equal to 50 μm and less than or equal to 75 μm, greater than or equal to 60 μm and less than or equal to 75 μm, greater than 0 μm and less than or equal to 60 μm, greater than or equal to 10 μm and less than or equal to 60 μm, greater than or equal to 25 μm and less than or equal to 60 μm, greater than or equal to 40 μm and less than or equal to 60 μm, greater than or equal to 50 μm and less than or equal to 60 μm, greater than 0 μm and less than or equal to 50 μm, greater than or equal to 10 μm and less than or equal to 50 μm, greater than or equal to 25 μm and less than or equal to 50 μm, greater than or equal to 40 μm and less than or equal to 50 μm, greater than 0 μm and less than or equal to 40 μm, greater than or equal to 10 μm and less than or equal to 40 μm, greater than or equal to 25 μm and less than or equal to 40 μm, greater than 0 μm and less than or equal to 25 μm, greater than or equal to 10 μm and less than or equal to 25 μm, greater than 0 μm and less than or equal to 10 μm, and all ranges and subranges there between.

Lithium ions may, in embodiments, be present in the anode 110 at depths greater than or equal to 0 μm and less than or equal to 100 μm, such as greater than or equal to 20 μm and less than or equal to 100 μm, greater than or equal to 40 μm and less than or equal to 100 μm, greater than or equal to 50 μm and less than or equal to 100 μm, greater than or equal to 60 μm and less than or equal to 100 μm, greater than or equal to 80 μm and less than or equal to 100 μm, greater than or equal to 0 μm and less than or equal to 80 μm, greater than or equal to 20 μm and less than or equal to 80 μm, greater than or equal to 40 μm and less than or equal to 80 μm, greater than or equal to 50 μm and less than or equal to 80 μm, greater than or equal to 60 μm and less than or equal to 80 μm, greater than or equal to 0 μm and less than or equal to 60 μm, greater than or equal to 20 μm and less than or equal to 60 μm, greater than or equal to 40 μm and less than or equal to 60 μm, greater than or equal to 50 μm and less than or equal to 60 μm, greater than or equal to 0 μm and less than or equal to 50 μm, greater than or equal to 20 μm and less than or equal to 50 μm, greater than or equal to 40 μm and less than or equal to 50 μm, greater than or equal to 0 μm and less than or equal to 40 μm, greater than or equal to 20 μm and less than or equal to 40 μm, or greater than or equal to 0 μm and less than or equal to 20 μm, and all ranges and subranges there between.

The magnesium layer 120 may be made from magnesium or any magnesium-based material suitable for use in a lithium-based solid-state battery, such as pure magnesium and a magnesium alloy. Suitable alloys include Mg—Li, Mg—Ca, Mg—Zn, and Mg—Al—Zn. Because magnesium is lithophilic and has a high lithium solubility, it promotes close interfacial contact with the anode 110 and the solid electrolyte 140 through chemical diffusion. This makes magnesium a good interlayer for attaching a lithium-containing anode 110 (such as a lithium or lithium-containing foil) using low pressure applications. This allows lithium-based solid-state batteries to be produced at low cost and high yield. Moreover, magnesium retains its framework with only moderate volume change when exposed to lithium plating and/or stripping cycles. According to embodiments, the magnesium layer 120 may be applied to the at least one metal layer 130 by physical vapor deposition (such as sputtering and evaporation), chemical vapor deposition, plating (such as electroplating and electroless plating), coating (such as spin coating or dip coating), or similar methods.

According to embodiments, the magnesium layer 120 has a thickness that is greater than or equal to 15 nm and less than or equal to 10,000 nm, such as greater than or equal to 50 nm and less than or equal to 10,000 nm, greater than or equal to 500 nm and less than or equal to 10,000 nm, greater than or equal to 1000 nm and less than or equal to 10,000 nm, greater than or equal to 1500 nm and less than or equal to 10,000 nm, greater than or equal to 2000 nm and less than or equal to 10,000 nm, greater than or equal to 3000 nm and less than or equal to 10,000 nm, greater than or equal to 4000 nm and less than or equal to 10,000 nm, greater than or equal to 5000 nm and less than or equal to 10,000 nm, greater than or equal to 6000 nm and less than or equal to 10,000 nm, greater than or equal to 7000 nm and less than or equal to 10,000 nm, greater than or equal to 8000 nm and less than or equal to 10,000 nm, greater than or equal to 9000 nm and less than or equal to 10,000 nm, greater than or equal to 15 nm and less than or equal to 9000 nm, greater than or equal to 50 nm and less than or equal to 9000 nm, greater than or equal to 500 nm and less than or equal to 9000 nm, greater than or equal to 1000 nm and less than or equal to 9000 nm, greater than or equal to 1500 nm and less than or equal to 9000 nm, greater than or equal to 2000 nm and less than or equal to 9000 nm, greater than or equal to 3000 nm and less than or equal to 9000 nm, greater than or equal to 4000 nm and less than or equal to 9000 nm, greater than or equal to 5000 nm and less than or equal to 9000 nm, greater than or equal to 6000 nm and less than or equal to 9000 nm, greater than or equal to 7000 nm and less than or equal to 9000 nm, greater than or equal to 8000 nm and less than or equal to 9000 nm, greater than or equal to 15 nm and less than or equal to 8000 nm, greater than or equal to 50 nm and less than or equal to 8000 nm, greater than or equal to 500 nm and less than or equal to 8000 nm, greater than or equal to 1000 nm and less than or equal to 8000 nm, greater than or equal to 1500 nm and less than or equal to 8000 nm, greater than or equal to 2000 nm and less than or equal to 8000 nm, greater than or equal to 3000 nm and less than or equal to 8000 nm, greater than or equal to 4000 nm and less than or equal to 8000 nm, greater than or equal to 5000 nm and less than or equal to 8000 nm, greater than or equal to 6000 nm and less than or equal to 8000 nm, greater than or equal to 7000 nm and less than or equal to 8000 nm, greater than or equal to 15 nm and less than or equal to 7000 nm, greater than or equal to 50 nm and less than or equal to 7000 nm, greater than or equal to 500 nm and less than or equal to 7000 nm, greater than or equal to 1000 nm and less than or equal to 7000 nm, greater than or equal to 1500 nm and less than or equal to 7000 nm, greater than or equal to 2000 nm and less than or equal to 7000 nm, greater than or equal to 3000 nm and less than or equal to 7000 nm, greater than or equal to 4000 nm and less than or equal to 7000 nm, greater than or equal to 5000 nm and less than or equal to 7000 nm, greater than or equal to 6000 nm and less than or equal to 7000 nm, greater than or equal to 15 nm and less than or equal to 6000 nm, greater than or equal to 50 nm and less than or equal to 6000 nm, greater than or equal to 500 nm and less than or equal to 6000 nm, greater than or equal to 1000 nm and less than or equal to 6000 nm, greater than or equal to 1500 nm and less than or equal to 6000 nm, greater than or equal to 2000 nm and less than or equal to 6000 nm, greater than or equal to 3000 nm and less than or equal to 6000 nm, greater than or equal to 4000 nm and less than or equal to 6000 nm, greater than or equal to 5000 nm and less than or equal to 6000 nm, greater than or equal to 15 nm and less than or equal to 5000 nm, greater than or equal to 50 nm and less than or equal to 5000 nm, greater than or equal to 500 nm and less than or equal to 5000 nm, greater than or equal to 1000 nm and less than or equal to 5000 nm, greater than or equal to 1500 nm and less than or equal to 5000 nm, greater than or equal to 2000 nm and less than or equal to 5000 nm, greater than or equal to 3000 nm and less than or equal to 5000 nm, greater than or equal to 4000 nm and less than or equal to 5000 nm, greater than or equal to 15 nm and less than or equal to 4000 nm, greater than or equal to 50 nm and less than or equal to 4000 nm, greater than or equal to 500 nm and less than or equal to 4000 nm, greater than or equal to 1000 nm and less than or equal to 4000 nm, greater than or equal to 1500 nm and less than or equal to 4000 nm, greater than or equal to 2000 nm and less than or equal to 4000 nm, greater than or equal to 3000 nm and less than or equal to 4000 nm, greater than or equal to 15 nm and less than or equal to 3000 nm, greater than or equal to 50 nm and less than or equal to 3000 nm, greater than or equal to 500 nm and less than or equal to 3000 nm, greater than or equal to 1000 nm and less than or equal to 3000 nm, greater than or equal to 1500 nm and less than or equal to 3000 nm, greater than or equal to 2000 nm and less than or equal to 3000 nm, greater than or equal to 15 nm and less than or equal to 2000 nm, greater than or equal to 50 nm and less than or equal to 2000 nm, greater than or equal to 500 nm and less than or equal to 2000 nm, greater than or equal to 1000 nm and less than or equal to 2000 nm, greater than or equal to 1500 nm and less than or equal to 2000 nm, greater than or equal to 15 nm and less than or equal to 1500 nm, greater than or equal to 50 nm and less than or equal to 1500 nm, greater than or equal to 500 nm and less than or equal to 1500 nm, greater than or equal to 1000 nm and less than or equal to 1500 nm, greater than or equal to 15 nm and less than or equal to 1000 nm, greater than or equal to 50 nm and less than or equal to 1000 nm, greater than or equal to 500 nm and less than or equal to 1000 nm, greater than or equal to 15 nm and less than or equal to 500 nm, greater than or equal to 50 nm and less than or equal to 500 nm, or greater than or equal to 15 nm and less than or equal to 50 nm, and all ranges and subranges there between.

In one or more embodiments the at least one metal layer 130 is selected from the group consisting of tin, silver, gold, platinum, aluminum, zinc, germanium, indium, gallium, antimony, bismuth, sodium, boron, and silicon. In embodiments, the at least one metal layer 130 is selected from silver, gold, or tin. By placing at least one lithophilic metal layer between the magnesium layer 120 and the solid electrolyte 140, the negative effects caused by directly depositing magnesium on the solid electrolyte 140 can be avoided. Moreover, the at least one metal layer 130 selected from the metals disclosed hereinabove have high lithium diffusivity and can adequately regulate lithium deposition. It is believed that synergistic effects of combining a magnesium layer 120 and at least one metal layer 130 between the anode 110 and the solid electrolyte 140 as described herein improve the contact and stability of the anode 110 and solid electrolyte 140 interface and can improve cell performance. According to embodiments, the at least one metal layer 130 may be applied to the solid electrolyte 140 by sputtering, chemical vapor deposition, physical vapor deposition, plating (such as electroplating and electroless plating), coating (such as spin coating or dip coating), or similar methods.

The thickness of the at least one metal layer 130 is, according to embodiments, greater than or equal to 10 nm and less than or equal to 10,000 nm, such as greater than or equal to 50 nm and less than or equal to 10,000 nm, greater than or equal to 500 nm and less than or equal to 10,000 nm, greater than or equal to 1000 nm and less than or equal to 10,000 nm, greater than or equal to 1500 nm and less than or equal to 10,000 nm, greater than or equal to 2000 nm and less than or equal to 10,000 nm, greater than or equal to 3000 nm and less than or equal to 10,000 nm, greater than or equal to 4000 nm and less than or equal to 10,000 nm, greater than or equal to 5000 nm and less than or equal to 10,000 nm, greater than or equal to 6000 nm and less than or equal to 10,000 nm, greater than or equal to 7000 nm and less than or equal to 10,000 nm, greater than or equal to 8000 nm and less than or equal to 10,000 nm, greater than or equal to 9000 nm and less than or equal to 10,000 nm, greater than or equal to 10 nm and less than or equal to 9000 nm, greater than or equal to 50 nm and less than or equal to 9000 nm, greater than or equal to 500 nm and less than or equal to 9000 nm, greater than or equal to 1000 nm and less than or equal to 9000 nm, greater than or equal to 1500 nm and less than or equal to 9000 nm, greater than or equal to 2000 nm and less than or equal to 9000 nm, greater than or equal to 3000 nm and less than or equal to 9000 nm, greater than or equal to 4000 nm and less than or equal to 9000 nm, greater than or equal to 5000 nm and less than or equal to 9000 nm, greater than or equal to 6000 nm and less than or equal to 9000 nm, greater than or equal to 7000 nm and less than or equal to 9000 nm, greater than or equal to 8000 nm and less than or equal to 9000 nm, greater than or equal to 10 nm and less than or equal to 8000 nm, greater than or equal to 50 nm and less than or equal to 8000 nm, greater than or equal to 500 nm and less than or equal to 8000 nm, greater than or equal to 1000 nm and less than or equal to 8000 nm, greater than or equal to 1500 nm and less than or equal to 8000 nm, greater than or equal to 2000 nm and less than or equal to 8000 nm, greater than or equal to 3000 nm and less than or equal to 8000 nm, greater than or equal to 4000 nm and less than or equal to 8000 nm, greater than or equal to 5000 nm and less than or equal to 8000 nm, greater than or equal to 6000 nm and less than or equal to 8000 nm, greater than or equal to 7000 nm and less than or equal to 8000 nm, greater than or equal to 10 nm and less than or equal to 7000 nm, greater than or equal to 50 nm and less than or equal to 7000 nm, greater than or equal to 500 nm and less than or equal to 7000 nm, greater than or equal to 1000 nm and less than or equal to 7000 nm, greater than or equal to 1500 nm and less than or equal to 7000 nm, greater than or equal to 2000 nm and less than or equal to 7000 nm, greater than or equal to 3000 nm and less than or equal to 7000 nm, greater than or equal to 4000 nm and less than or equal to 7000 nm, greater than or equal to 5000 nm and less than or equal to 7000 nm, greater than or equal to 6000 nm and less than or equal to 7000 nm, greater than or equal to 10 nm and less than or equal to 6000 nm, greater than or equal to 50 nm and less than or equal to 6000 nm, greater than or equal to 500 nm and less than or equal to 6000 nm, greater than or equal to 1000 nm and less than or equal to 6000 nm, greater than or equal to 1500 nm and less than or equal to 6000 nm, greater than or equal to 2000 nm and less than or equal to 6000 nm, greater than or equal to 3000 nm and less than or equal to 6000 nm, greater than or equal to 4000 nm and less than or equal to 6000 nm, greater than or equal to 5000 nm and less than or equal to 6000 nm, greater than or equal to 10 nm and less than or equal to 5000 nm, greater than or equal to 50 nm and less than or equal to 5000 nm, greater than or equal to 500 nm and less than or equal to 5000 nm, greater than or equal to 1000 nm and less than or equal to 5000 nm, greater than or equal to 1500 nm and less than or equal to 5000 nm, greater than or equal to 2000 nm and less than or equal to 5000 nm, greater than or equal to 3000 nm and less than or equal to 5000 nm, greater than or equal to 4000 nm and less than or equal to 5000 nm, greater than or equal to 10 nm and less than or equal to 4000 nm, greater than or equal to 50 nm and less than or equal to 4000 nm, greater than or equal to 500 nm and less than or equal to 4000 nm, greater than or equal to 1000 nm and less than or equal to 4000 nm, greater than or equal to 1500 nm and less than or equal to 4000 nm, greater than or equal to 2000 nm and less than or equal to 4000 nm, greater than or equal to 3000 nm and less than or equal to 4000 nm, greater than or equal to 10 nm and less than or equal to 3000 nm, greater than or equal to 50 nm and less than or equal to 3000 nm, greater than or equal to 500 nm and less than or equal to 3000 nm, greater than or equal to 1000 nm and less than or equal to 3000 nm, greater than or equal to 1500 nm and less than or equal to 3000 nm, greater than or equal to 2000 nm and less than or equal to 3000 nm, greater than or equal to 10 nm and less than or equal to 2000 nm, greater than or equal to 50 nm and less than or equal to 2000 nm, greater than or equal to 500 nm and less than or equal to 2000 nm, greater than or equal to 1000 nm and less than or equal to 2000 nm, greater than or equal to 1500 nm and less than or equal to 2000 nm, greater than or equal to 10 nm and less than or equal to 1500 nm, greater than or equal to 50 nm and less than or equal to 1500 nm, greater than or equal to 500 nm and less than or equal to 1500 nm, greater than or equal to 1000 nm and less than or equal to 1500 nm, greater than or equal to 10 nm and less than or equal to 1000 nm, greater than or equal to 50 nm and less than or equal to 1000 nm, greater than or equal to 500 nm and less than or equal to 1000 nm, greater than or equal to 10 nm and less than or equal to 500 nm, greater than or equal to 50 nm and less than or equal to 500 nm, or greater than or equal to 10 nm and less than or equal to 50 nm, and all ranges and subranges there between.

The solid electrolyte 140 is, in one or more embodiments, a garnet-type electrolyte, such as lithium lanthanum zirconium oxide. And, in embodiments, the solid electrolyte is tantalum-doped lithium lanthanum zirconium oxide, aluminum-doped lanthanum zirconium oxide, gallium-doped lanthanum zirconium oxide, and niobium-doped lanthanum zirconium oxide The thickness of the solid electrolyte 140 may, in embodiments, be greater than or equal to 0.01 mm and less than or equal to 2.00 mm, such as greater than or equal to 0.25 mm and less than or equal to 2.00 mm, greater than or equal to 0.50 mm and less than or equal to 2.00 mm, greater than or equal to 0.75 mm and less than or equal to 2.00 mm, greater than or equal to 1.00 mm and less than or equal to 2.00 mm, greater than or equal to 1.25 mm and less than or equal to 2.00 mm, greater than or equal to 1.50 mm and less than or equal to 2.00 mm, greater than or equal to 1.75 mm and less than or equal to 2.00 mm, greater than or equal to 0.01 mm and less than or equal to 1.75 mm, greater than or equal to 0.25 mm and less than or equal to 1.75 mm, greater than or equal to 0.50 mm and less than or equal to 1.75 mm, greater than or equal to 0.75 mm and less than or equal to 1.75 mm, greater than or equal to 1.00 mm and less than or equal to 1.75 mm, greater than or equal to 1.25 mm and less than or equal to 1.75 mm, greater than or equal to 1.50 mm and less than or equal to 1.75 mm, greater than or equal to 0.01 mm and less than or equal to 1.50 mm, greater than or equal to 0.25 mm and less than or equal to 1.50 mm, greater than or equal to 0.50 mm and less than or equal to 1.50 mm, greater than or equal to 0.75 mm and less than or equal to 1.50 mm, greater than or equal to 1.00 mm and less than or equal to 1.50 mm, greater than or equal to 1.25 mm and less than or equal to 1.50 mm, greater than or equal to 0.01 mm and less than or equal to 1.25 mm, greater than or equal to 0.25 mm and less than or equal to 1.25 mm, greater than or equal to 0.50 mm and less than or equal to 1.25 mm, greater than or equal to 0.75 mm and less than or equal to 1.25 mm, greater than or equal to 1.00 mm and less than or equal to 1.25 mm, greater than or equal to 0.01 mm and less than or equal to 1.00 mm, greater than or equal to 0.25 mm and less than or equal to 1.00 mm, greater than or equal to 0.50 mm and less than or equal to 1.00 mm, greater than or equal to 0.75 mm and less than or equal to 1.00 mm, greater than or equal to 0.01 mm and less than or equal to 0.75 mm, greater than or equal to 0.25 mm and less than or equal to 0.75 mm, greater than or equal to 0.50 mm and less than or equal to 0.75 mm, greater than or equal to 0.01 mm and less than or equal to 0.50 mm, greater than or equal to 0.25 mm and less than or equal to 0.50 mm, greater than or equal to 0.01 mm and less than or equal to 0.25 mm, and all ranges and subranges there between.

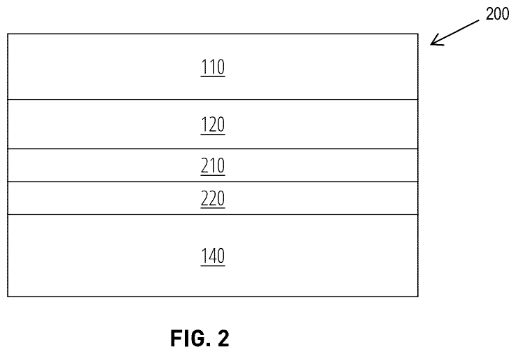

With reference now to FIG. 2, a cross-section view of an asymmetric solid-state cell 200 according to embodiments disclosed and described herein is provided. The anode 110, magnesium layer 120, and solid electrolyte 140 depicted in FIG. 2 are the same as described hereinabove. The asymmetric solid-state cell 200 includes an anode 110 that is configured to contain lithium when the asymmetric solid-state cell 100 is in a charged state. Adjacent to the anode 110 is a magnesium layer 120. It should be understood that the magnesium layer 120 may be physically or electrically connected to the anode 110 such that lithium ions can transition from the anode 110 to the magnesium layer 120. This magnesium layer 120 can promote increased lithium diffusion and improve the intercalation/extraction cycling life of the asymmetric solid-state cell 100. At least one metal layer is positioned between the magnesium layer 120 and a solid electrolyte 140. The at least one metal layer comprises a first metal layer 210 and a second metal layer 220. The first metal layer 210 is positioned adjacent to the magnesium layer 120. It should be understood that the first metal layer 210 may be physically or electrically connected to the magnesium layer 120 such that lithium ions can transition from the magnesium layer 120 to the first metal layer 210. The second metal layer 220 is positioned adjacent to the first metal layer 210. It should be understood that the second metal layer 220 may be physically or electrically connected to the first metal layer 210 such that lithium ions can transition from the first metal layer 210 to the second metal layer 220. A solid electrolyte 140 is positioned adjacent to the second metal layer 220. The solid electrolyte 140 may be physically or chemically connected to the second metal layer 220 such that lithium ions can transition from the second metal layer 220 to the solid electrolyte 140. The first metal layer 210 and the second metal layer 220 are believed to improve the interfacial contact to the solid electrolyte 140, thereby decreasing the resistance between the solid electrolyte 140 and the anode 110 compared to a solid-state cell where a magnesium layer is adjacent to the solid electrolyte. Without being bound by any particular theory, it is believed that having two or more metal layers may provide synergistic benefits from the differing features of the two or more metal layers. For example, metals such as Ag possess high Li diffusion coefficients and a first metal layer made from Ag might facilitate preferential Li deposition location and enable stable cycling performance However, metals such as Sn as second metal layer 220 after lithiation/delithiation cycles will likely remain at the interface without element distribution, thereby promoting the interface stability.

The first metal layer 210 is, in embodiments, selected from the group consisting of tin, silver, gold, platinum, aluminum, zinc, germanium, indium, gallium, antimony, bismuth, sodium, boron, and silicon, and the second metal layer 220 is selected from the group consisting of tin, silver, gold, platinum, aluminum, zinc, germanium, indium, gallium, antimony, bismuth, sodium, boron, and silicon. In one or more embodiments, the first metal layer 210 is made from a different metal than the second metal layer 220. In particular embodiments, the first metal layer 210 is made from silver and the second metal layer 220 is made from tin. In embodiments, the first metal layer 210 and the second metal layer 220 may be applied to either the second metal layer 220 or the solid electrolyte 140, respectively, by sputtering, chemical vapor deposition, physical vapor deposition, plating (such as electroplating and electroless plating), coating (such as spin coating or dip coating), or similar methods.

In embodiments, the thickness of the first metal layer 210 and the second metal layer 220 may individually be greater than or equal to 10 nm and less than or equal to 10,000 nm, such as greater than or equal to 50 nm and less than or equal to 10,000 nm, greater than or equal to 500 nm and less than or equal to 10,000 nm, greater than or equal to 1000 nm and less than or equal to 10,000 nm, greater than or equal to 1500 nm and less than or equal to 10,000 nm, greater than or equal to 2000 nm and less than or equal to 10,000 nm, greater than or equal to 3000 nm and less than or equal to 10,000 nm, greater than or equal to 4000 nm and less than or equal to 10,000 nm, greater than or equal to 5000 nm and less than or equal to 10,000 nm, greater than or equal to 6000 nm and less than or equal to 10,000 nm, greater than or equal to 7000 nm and less than or equal to 10,000 nm, greater than or equal to 8000 nm and less than or equal to 10,000 nm, greater than or equal to 9000 nm and less than or equal to 10,000 nm, greater than or equal to 10 nm and less than or equal to 9000 nm, greater than or equal to 50 nm and less than or equal to 9000 nm, greater than or equal to 500 nm and less than or equal to 9000 nm, greater than or equal to 1000 nm and less than or equal to 9000 nm, greater than or equal to 1500 nm and less than or equal to 9000 nm, greater than or equal to 2000 nm and less than or equal to 9000 nm, greater than or equal to 3000 nm and less than or equal to 9000 nm, greater than or equal to 4000 nm and less than or equal to 9000 nm, greater than or equal to 5000 nm and less than or equal to 9000 nm, greater than or equal to 6000 nm and less than or equal to 9000 nm, greater than or equal to 7000 nm and less than or equal to 9000 nm, greater than or equal to 8000 nm and less than or equal to 9000 nm, greater than or equal to 10 nm and less than or equal to 8000 nm, greater than or equal to 50 nm and less than or equal to 8000 nm, greater than or equal to 500 nm and less than or equal to 8000 nm, greater than or equal to 1000 nm and less than or equal to 8000 nm, greater than or equal to 1500 nm and less than or equal to 8000 nm, greater than or equal to 2000 nm and less than or equal to 8000 nm, greater than or equal to 3000 nm and less than or equal to 8000 nm, greater than or equal to 4000 nm and less than or equal to 8000 nm, greater than or equal to 5000 nm and less than or equal to 8000 nm, greater than or equal to 6000 nm and less than or equal to 8000 nm, greater than or equal to 7000 nm and less than or equal to 8000 nm, greater than or equal to 10 nm and less than or equal to 7000 nm, greater than or equal to 50 nm and less than or equal to 7000 nm, greater than or equal to 500 nm and less than or equal to 7000 nm, greater than or equal to 1000 nm and less than or equal to 7000 nm, greater than or equal to 1500 nm and less than or equal to 7000 nm, greater than or equal to 2000 nm and less than or equal to 7000 nm, greater than or equal to 3000 nm and less than or equal to 7000 nm, greater than or equal to 4000 nm and less than or equal to 7000 nm, greater than or equal to 5000 nm and less than or equal to 7000 nm, greater than or equal to 6000 nm and less than or equal to 7000 nm, greater than or equal to 10 nm and less than or equal to 6000 nm, greater than or equal to 50 nm and less than or equal to 6000 nm, greater than or equal to 500 nm and less than or equal to 6000 nm, greater than or equal to 1000 nm and less than or equal to 6000 nm, greater than or equal to 1500 nm and less than or equal to 6000 nm, greater than or equal to 2000 nm and less than or equal to 6000 nm, greater than or equal to 3000 nm and less than or equal to 6000 nm, greater than or equal to 4000 nm and less than or equal to 6000 nm, greater than or equal to 5000 nm and less than or equal to 6000 nm, greater than or equal to 10 nm and less than or equal to 5000 nm, greater than or equal to 50 nm and less than or equal to 5000 nm, greater than or equal to 500 nm and less than or equal to 5000 nm, greater than or equal to 1000 nm and less than or equal to 5000 nm, greater than or equal to 1500 nm and less than or equal to 5000 nm, greater than or equal to 2000 nm and less than or equal to 5000 nm, greater than or equal to 3000 nm and less than or equal to 5000 nm, greater than or equal to 4000 nm and less than or equal to 5000 nm, greater than or equal to 10 nm and less than or equal to 4000 nm, greater than or equal to 50 nm and less than or equal to 4000 nm, greater than or equal to 500 nm and less than or equal to 4000 nm, greater than or equal to 1000 nm and less than or equal to 4000 nm, greater than or equal to 1500 nm and less than or equal to 4000 nm, greater than or equal to 2000 nm and less than or equal to 4000 nm, greater than or equal to 3000 nm and less than or equal to 4000 nm, greater than or equal to 10 nm and less than or equal to 3000 nm, greater than or equal to 50 nm and less than or equal to 3000 nm, greater than or equal to 500 nm and less than or equal to 3000 nm, greater than or equal to 1000 nm and less than or equal to 3000 nm, greater than or equal to 1500 nm and less than or equal to 3000 nm, greater than or equal to 2000 nm and less than or equal to 3000 nm, greater than or equal to 10 nm and less than or equal to 2000 nm, greater than or equal to 50 nm and less than or equal to 2000 nm, greater than or equal to 500 nm and less than or equal to 2000 nm, greater than or equal to 1000 nm and less than or equal to 2000 nm, greater than or equal to 1500 nm and less than or equal to 2000 nm, greater than or equal to 10 nm and less than or equal to 1500 nm, greater than or equal to 50 nm and less than or equal to 1500 nm, greater than or equal to 500 nm and less than or equal to 1500 nm, greater than or equal to 1000 nm and less than or equal to 1500 nm, greater than or equal to 10 nm and less than or equal to 1000 nm, greater than or equal to 50 nm and less than or equal to 1000 nm, greater than or equal to 500 nm and less than or equal to 1000 nm, greater than or equal to 10 nm and less than or equal to 500 nm, greater than or equal to 50 nm and less than or equal to 500 nm, or greater than or equal to 10 nm and less than or equal to 50 nm, and all ranges and subranges there between.

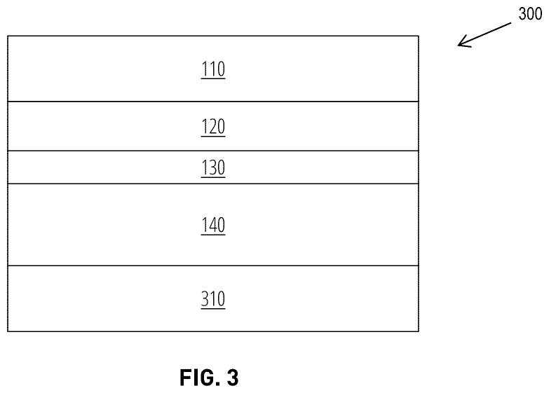

With reference now to FIG. 3, a cross-section view of a symmetric solid-state cell 300 according to embodiments disclosed and described herein is provided. The symmetric solid-state cell 300 includes an anode 110 that is configured to contain lithium when the symmetric solid-state cell 300 is in a charged state. Adjacent to the anode 110 is a magnesium layer 120. It should be understood that the magnesium layer 120 may be physically or electrically connected to the anode 110 such that lithium ions can transition from the anode 110 to the magnesium layer 120. This magnesium layer 120 can promote increased lithium diffusion and improve the intercalation/extraction cycling life of the asymmetric solid-state cell 100. At least one metal layer 130 is positioned adjacent to the magnesium layer 120 such that lithium ions can transition from the magnesium layer 120 to the at least one metal layer 130. A solid electrolyte 140 is positioned adjacent to at least one metal layer 130. The solid electrolyte 140 may be physically or electrically connected to the at least one metal layer 130 such that lithium ions can transition from the at least one metal layer 130 to the solid electrolyte 140. A second electrode 310 is adjacent to the solid electrolyte 140, and on a side of the solid electrolyte 140 opposite of the at least one metal layer 130, the magnesium layer 120, and the anode 110. It should be understood that the second electrode 310 is physically or electrically connected to the solid electrolyte 140 such that lithium ions transition from the solid electrolyte 140 to the second electrode 310 when the solid-state battery is being discharged, and so that lithium ions transition from the second electrode 310 to the solid electrolyte 140 when the solid-state battery is being charged. The at least one metal layer 130 is believed to improve the interfacial contact to the solid electrolyte 140, thereby decreasing the resistance between the solid electrolyte 140 and the anode 110 compared to a solid-state cell where a magnesium layer is adjacent to the solid electrolyte.

The anode 110, magnesium layer 120, at least one metal layer 130, and solid electrolyte 140 may, in embodiments, individually be the same as those described above with reference to FIG. 1. Moreover, in one or more embodiments, the at least one metal layer 130 depicted in FIG. 3 may be a first metal layer and a second metal layer as described with reference to FIG. 2. The second electrode 310 may, according to embodiments, be selected from the group consisting of lithium cobalt oxide, lithium manganese oxide, lithium iron phosphate, lithium nickel manganese cobalt oxide, lithium manganese iron phosphate (LMFP), and lithium nickel manganese oxide (LNMO). In one or more embodiments, the second electrode 310 is made from lithium cobalt oxide. According to embodiments, the thickness of the second electrode 310 is greater than or equal to 50 mm and less than or equal to 200 mm, such as greater than or equal to 75 mm and less than or equal to 200 mm, greater than or equal to 100 mm and less than or equal to 200 mm, greater than or equal to 125 mm and less than or equal to 200 mm, greater than or equal to 150 mm and less than or equal to 200 mm, greater than or equal to 175 mm and less than or equal to 200 mm, greater than or equal to 50 mm and less than or equal to 175 mm, greater than or equal to 75 mm and less than or equal to 175 mm, greater than or equal to 100 mm and less than or equal to 175 mm, greater than or equal to 125 mm and less than or equal to 175 mm, greater than or equal to 150 mm and less than or equal to 175 mm, greater than or equal to 50 mm and less than or equal to 150 mm, greater than or equal to 75 mm and less than or equal to 150 mm, greater than or equal to 100 mm and less than or equal to 150 mm, greater than or equal to 125 mm and less than or equal to 150 mm, greater than or equal to 50 mm and less than or equal to 125 mm, greater than or equal to 75 mm and less than or equal to 125 mm, greater than or equal to 100 mm and less than or equal to 125 mm, greater than or equal to 50 mm and less than or equal to 100 mm, greater than or equal to 75 mm and less than or equal to 100 mm, greater than or equal to 50 mm and less than or equal to 75 mm, and all ranges and subranges there between.

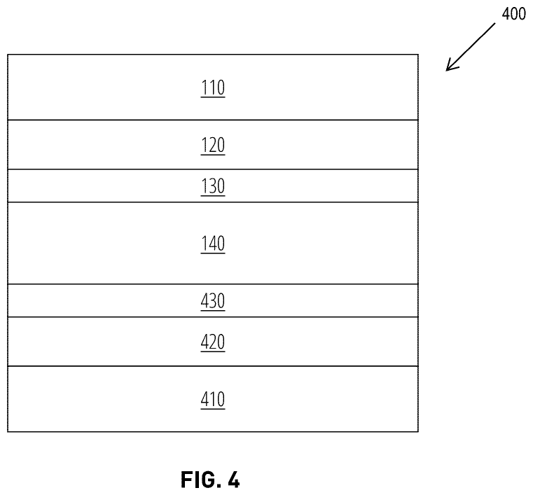

With reference now to FIG. 4, a cross-section view of a symmetric solid-state cell 400 according to embodiments disclosed and described herein is provided. The symmetric solid-state cell 400 includes an anode 110 that is configured to contain lithium when the symmetric solid-state cell 400 is in a charged state. Adjacent to the anode 110 is a magnesium layer 120. It should be understood that the magnesium layer 120 may be physically or electrically connected to the anode 110 such that lithium ions can transition from the anode 110 to the magnesium layer 120. This magnesium layer 120 can promote increased lithium diffusion and improve the intercalation/extraction cycling life of the symmetric solid-state cell 400. At least one metal layer 130 is positioned adjacent to the magnesium layer 120 such that lithium ions can transition from the magnesium layer 120 to the at least one metal layer 130. A solid electrolyte 140 is positioned adjacent to at least one metal layer 130. The solid electrolyte 140 may be physically or electrically connected to the at least one metal layer 130 such that lithium ions can transition from the at least one metal layer 130 to the solid electrolyte 140. At least one additional metal layer 430 is adjacent to the solid electrolyte 140 and physically or electrically connected to the solid electrolyte 140 such that lithium ions can transition from the solid electrolyte 140 to the at least one additional metal layer 430. A second magnesium layer 420 is adjacent to the at least one additional metal layer 430 and physically or electrically connected to the at least one additional metal layer 430 such that lithium ions can transition from the at least one additional metal layer 430 to the second magnesium layer 420. A second electrode 410 is positioned adjacent to the second magnesium layer 420 and is physically or chemically connected to the second magnesium layer 420 such that lithium ions can transition from the second magnesium layer 420 to the second electrode 310.

The anode 110, magnesium layer 120, the at least one metal layer 130, and the solid electrolyte 140 may, in embodiments, individually be the same as those described above with reference to FIG. 1. Moreover, in one or more embodiments, the at least one metal layer 130 depicted in FIG. 4 may be a first metal layer and a second metal layer as described with reference to FIG. 2.

The at least one additional metal layer 430 can be the same as the at least one metal layer 130 described elsewhere herein. For example, in embodiments, the at least one additional metal layer 430 is selected from the group consisting of tin, silver, gold, platinum, aluminum, zinc, germanium, indium, gallium, antimony, bismuth, sodium, boron, and silicon. In embodiments, the at least one additional metal layer 430 is selected from silver, gold, or tin. By placing a at least one lithophilic metal layer between the second magnesium layer 420 and the solid electrolyte 140, the negative effects caused by directly depositing magnesium on the solid electrolyte 140 can be avoided. Moreover, the at least one additional metal layer 430 selected from the metals disclosed hereinabove have high lithium diffusivity and can adequately regulate lithium deposition. It is believed that synergistic effects of combining a second magnesium layer 420 and at least one additional metal layer 430 between the second electrode 410 and the solid electrolyte 140 as described herein improve the contact and stability of the second electrode 410 and solid electrolyte 140 interface and can improve cell performance. According to embodiments, the at least one additional metal layer 430 may be applied to the solid electrolyte 140 by sputtering, chemical vapor deposition, physical vapor deposition, plating (such as electroplating and electroless plating), coating (such as spin coating or dip coating), or similar methods.

The thickness of the at least one additional metal layer 430 is, according to embodiments, greater than or equal to 10 nm and less than or equal to 10,000 nm, such as greater than or equal to 50 nm and less than or equal to 10,000 nm, greater than or equal to 500 nm and less than or equal to 10,000 nm, greater than or equal to 1000 nm and less than or equal to 10,000 nm, greater than or equal to 1500 nm and less than or equal to 10,000 nm, greater than or equal to 2000 nm and less than or equal to 10,000 nm, greater than or equal to 3000 nm and less than or equal to 10,000 nm, greater than or equal to 4000 nm and less than or equal to 10,000 nm, greater than or equal to 5000 nm and less than or equal to 10,000 nm, greater than or equal to 6000 nm and less than or equal to 10,000 nm, greater than or equal to 7000 nm and less than or equal to 10,000 nm, greater than or equal to 8000 nm and less than or equal to 10,000 nm, greater than or equal to 9000 nm and less than or equal to 10,000 nm, greater than or equal to 10 nm and less than or equal to 9000 nm, greater than or equal to 50 nm and less than or equal to 9000 nm, greater than or equal to 500 nm and less than or equal to 9000 nm, greater than or equal to 1000 nm and less than or equal to 9000 nm, greater than or equal to 1500 nm and less than or equal to 9000 nm, greater than or equal to 2000 nm and less than or equal to 9000 nm, greater than or equal to 3000 nm and less than or equal to 9000 nm, greater than or equal to 4000 nm and less than or equal to 9000 nm, greater than or equal to 5000 nm and less than or equal to 9000 nm, greater than or equal to 6000 nm and less than or equal to 9000 nm, greater than or equal to 7000 nm and less than or equal to 9000 nm, greater than or equal to 8000 nm and less than or equal to 9000 nm, greater than or equal to 10 nm and less than or equal to 8000 nm, greater than or equal to 50 nm and less than or equal to 8000 nm, greater than or equal to 500 nm and less than or equal to 8000 nm, greater than or equal to 1000 nm and less than or equal to 8000 nm, greater than or equal to 1500 nm and less than or equal to 8000 nm, greater than or equal to 2000 nm and less than or equal to 8000 nm, greater than or equal to 3000 nm and less than or equal to 8000 nm, greater than or equal to 4000 nm and less than or equal to 8000 nm, greater than or equal to 5000 nm and less than or equal to 8000 nm, greater than or equal to 6000 nm and less than or equal to 8000 nm, greater than or equal to 7000 nm and less than or equal to 8000 nm, greater than or equal to 10 nm and less than or equal to 7000 nm, greater than or equal to 50 nm and less than or equal to 7000 nm, greater than or equal to 500 nm and less than or equal to 7000 nm, greater than or equal to 1000 nm and less than or equal to 7000 nm, greater than or equal to 1500 nm and less than or equal to 7000 nm, greater than or equal to 2000 nm and less than or equal to 7000 nm, greater than or equal to 3000 nm and less than or equal to 7000 nm, greater than or equal to 4000 nm and less than or equal to 7000 nm, greater than or equal to 5000 nm and less than or equal to 7000 nm, greater than or equal to 6000 nm and less than or equal to 7000 nm, greater than or equal to 10 nm and less than or equal to 6000 nm, greater than or equal to 50 nm and less than or equal to 6000 nm, greater than or equal to 500 nm and less than or equal to 6000 nm, greater than or equal to 1000 nm and less than or equal to 6000 nm, greater than or equal to 1500 nm and less than or equal to 6000 nm, greater than or equal to 2000 nm and less than or equal to 6000 nm, greater than or equal to 3000 nm and less than or equal to 6000 nm, greater than or equal to 4000 nm and less than or equal to 6000 nm, greater than or equal to 5000 nm and less than or equal to 6000 nm, greater than or equal to 10 nm and less than or equal to 5000 nm, greater than or equal to 50 nm and less than or equal to 5000 nm, greater than or equal to 500 nm and less than or equal to 5000 nm, greater than or equal to 1000 nm and less than or equal to 5000 nm, greater than or equal to 1500 nm and less than or equal to 5000 nm, greater than or equal to 2000 nm and less than or equal to 5000 nm, greater than or equal to 3000 nm and less than or equal to 5000 nm, greater than or equal to 4000 nm and less than or equal to 5000 nm, greater than or equal to 10 nm and less than or equal to 4000 nm, greater than or equal to 50 nm and less than or equal to 4000 nm, greater than or equal to 500 nm and less than or equal to 4000 nm, greater than or equal to 1000 nm and less than or equal to 4000 nm, greater than or equal to 1500 nm and less than or equal to 4000 nm, greater than or equal to 2000 nm and less than or equal to 4000 nm, greater than or equal to 3000 nm and less than or equal to 4000 nm, greater than or equal to 10 nm and less than or equal to 3000 nm, greater than or equal to 50 nm and less than or equal to 3000 nm, greater than or equal to 500 nm and less than or equal to 3000 nm, greater than or equal to 1000 nm and less than or equal to 3000 nm, greater than or equal to 1500 nm and less than or equal to 3000 nm, greater than or equal to 2000 nm and less than or equal to 3000 nm, greater than or equal to 10 nm and less than or equal to 2000 nm, greater than or equal to 50 nm and less than or equal to 2000 nm, greater than or equal to 500 nm and less than or equal to 2000 nm, greater than or equal to 1000 nm and less than or equal to 2000 nm, greater than or equal to 1500 nm and less than or equal to 2000 nm, greater than or equal to 10 nm and less than or equal to 1500 nm, greater than or equal to 50 nm and less than or equal to 1500 nm, greater than or equal to 500 nm and less than or equal to 1500 nm, greater than or equal to 1000 nm and less than or equal to 1500 nm, greater than or equal to 10 nm and less than or equal to 1000 nm, greater than or equal to 50 nm and less than or equal to 1000 nm, greater than or equal to 500 nm and less than or equal to 1000 nm, greater than or equal to 10 nm and less than or equal to 500 nm, greater than or equal to 50 nm and less than or equal to 500 nm, or greater than or equal to 10 nm and less than or equal to 50 nm, and all ranges and subranges there between.

The second magnesium layer 420 may be made from the same materials described elsewhere herein for the magnesium layer 120. For example, in embodiments, the second magnesium layer 420 may be made from magnesium or any magnesium-based material suitable for use in a lithium-based solid-state battery, such as a magnesium alloy. Because magnesium is lithophilic and has a high lithium solubility, it promotes close interfacial contact with the second electrode 410 and the solid electrolyte 140 through chemical diffusion. This makes magnesium a good interlayer for attaching a lithium-containing second electrode 410 (such as a lithium or lithium-containing foil) using low-pressure applications. This allows lithium-based solid-state batteries to be produced at low cost and high yield. Moreover, magnesium retains its framework with only moderate volume change when exposed to lithium plating and/or stripping cycles.

According to embodiments, the second magnesium layer 420 has a thickness that is greater than or equal to 15 nm and less than or equal to 10,000 nm, such as greater than or equal to 50 nm and less than or equal to 10,000 nm, greater than or equal to 500 nm and less than or equal to 10,000 nm, greater than or equal to 1000 nm and less than or equal to 10,000 nm, greater than or equal to 1500 nm and less than or equal to 10,000 nm, greater than or equal to 2000 nm and less than or equal to 10,000 nm, greater than or equal to 3000 nm and less than or equal to 10,000 nm, greater than or equal to 4000 nm and less than or equal to 10,000 nm, greater than or equal to 5000 nm and less than or equal to 10,000 nm, greater than or equal to 6000 nm and less than or equal to 10,000 nm, greater than or equal to 7000 nm and less than or equal to 10,000 nm, greater than or equal to 8000 nm and less than or equal to 10,000 nm, greater than or equal to 9000 nm and less than or equal to 10,000 nm, greater than or equal to 15 nm and less than or equal to 9000 nm, greater than or equal to 50 nm and less than or equal to 9000 nm, greater than or equal to 500 nm and less than or equal to 9000 nm, greater than or equal to 1000 nm and less than or equal to 9000 nm, greater than or equal to 1500 nm and less than or equal to 9000 nm, greater than or equal to 2000 nm and less than or equal to 9000 nm, greater than or equal to 3000 nm and less than or equal to 9000 nm, greater than or equal to 4000 nm and less than or equal to 9000 nm, greater than or equal to 5000 nm and less than or equal to 9000 nm, greater than or equal to 6000 nm and less than or equal to 9000 nm, greater than or equal to 7000 nm and less than or equal to 9000 nm, greater than or equal to 8000 nm and less than or equal to 9000 nm, greater than or equal to 15 nm and less than or equal to 8000 nm, greater than or equal to 50 nm and less than or equal to 8000 nm, greater than or equal to 500 nm and less than or equal to 8000 nm, greater than or equal to 1000 nm and less than or equal to 8000 nm, greater than or equal to 1500 nm and less than or equal to 8000 nm, greater than or equal to 2000 nm and less than or equal to 8000 nm, greater than or equal to 3000 nm and less than or equal to 8000 nm, greater than or equal to 4000 nm and less than or equal to 8000 nm, greater than or equal to 5000 nm and less than or equal to 8000 nm, greater than or equal to 6000 nm and less than or equal to 8000 nm, greater than or equal to 7000 nm and less than or equal to 8000 nm, greater than or equal to 15 nm and less than or equal to 7000 nm, greater than or equal to 50 nm and less than or equal to 7000 nm, greater than or equal to 500 nm and less than or equal to 7000 nm, greater than or equal to 1000 nm and less than or equal to 7000 nm, greater than or equal to 1500 nm and less than or equal to 7000 nm, greater than or equal to 2000 nm and less than or equal to 7000 nm, greater than or equal to 3000 nm and less than or equal to 7000 nm, greater than or equal to 4000 nm and less than or equal to 7000 nm, greater than or equal to 5000 nm and less than or equal to 7000 nm, greater than or equal to 6000 nm and less than or equal to 7000 nm, greater than or equal to 15 nm and less than or equal to 6000 nm, greater than or equal to 50 nm and less than or equal to 6000 nm, greater than or equal to 500 nm and less than or equal to 6000 nm, greater than or equal to 1000 nm and less than or equal to 6000 nm, greater than or equal to 1500 nm and less than or equal to 6000 nm, greater than or equal to 2000 nm and less than or equal to 6000 nm, greater than or equal to 3000 nm and less than or equal to 6000 nm, greater than or equal to 4000 nm and less than or equal to 6000 nm, greater than or equal to 5000 nm and less than or equal to 6000 nm, greater than or equal to 15 nm and less than or equal to 5000 nm, greater than or equal to 50 nm and less than or equal to 5000 nm, greater than or equal to 500 nm and less than or equal to 5000 nm, greater than or equal to 1000 nm and less than or equal to 5000 nm, greater than or equal to 1500 nm and less than or equal to 5000 nm, greater than or equal to 2000 nm and less than or equal to 5000 nm, greater than or equal to 3000 nm and less than or equal to 5000 nm, greater than or equal to 4000 nm and less than or equal to 5000 nm, greater than or equal to 15 nm and less than or equal to 4000 nm, greater than or equal to 50 nm and less than or equal to 4000 nm, greater than or equal to 500 nm and less than or equal to 4000 nm, greater than or equal to 1000 nm and less than or equal to 4000 nm, greater than or equal to 1500 nm and less than or equal to 4000 nm, greater than or equal to 2000 nm and less than or equal to 4000 nm, greater than or equal to 3000 nm and less than or equal to 4000 nm, greater than or equal to 15 nm and less than or equal to 3000 nm, greater than or equal to 50 nm and less than or equal to 3000 nm, greater than or equal to 500 nm and less than or equal to 3000 nm, greater than or equal to 1000 nm and less than or equal to 3000 nm, greater than or equal to 1500 nm and less than or equal to 3000 nm, greater than or equal to 2000 nm and less than or equal to 3000 nm, greater than or equal to 15 nm and less than or equal to 2000 nm, greater than or equal to 50 nm and less than or equal to 2000 nm, greater than or equal to 500 nm and less than or equal to 2000 nm, greater than or equal to 1000 nm and less than or equal to 2000 nm, greater than or equal to 1500 nm and less than or equal to 2000 nm, greater than or equal to 15 nm and less than or equal to 1500 nm, greater than or equal to 50 nm and less than or equal to 1500 nm, greater than or equal to 500 nm and less than or equal to 1500 nm, greater than or equal to 1000 nm and less than or equal to 1500 nm, greater than or equal to 15 nm and less than or equal to 1000 nm, greater than or equal to 50 nm and less than or equal to 1000 nm, greater than or equal to 500 nm and less than or equal to 1000 nm, greater than or equal to 15 nm and less than or equal to 500 nm, greater than or equal to 50 nm and less than or equal to 500 nm, or greater than or equal to 15 nm and less than or equal to 50 nm, and all ranges and subranges there between.

The second electrode 410 may be applied to the second magnesium layer 420 by attaching (pressing, melting and depositing, such as PVD, electrochemical precipitation) lithium or lithium-containing foils to the second magnesium layer 420. In embodiments, the Second electrode 410 has a thickness that is greater than 0 μm and less than or equal to 100 μm, such as greater than or equal to 10 μm and less than or equal to 100 μm, greater than or equal to 25 μm and less than or equal to 100 μm, greater than or equal to 40 μm and less than or equal to 100 μm, greater than or equal to 50 μm and less than or equal to 100 μm, greater than or equal to 60 μm and less than or equal to 100 μm, greater than or equal to 75 μm and less than or equal to 100 μm, greater than or equal to 90 μm and less than or equal to 100 μm, greater than 0 μm and less than or equal to 90 μm, greater than or equal to 10 μm and less than or equal to 90 μm, greater than or equal to 25 μm and less than or equal to 90 μm, greater than or equal to 40 μm and less than or equal to 90 μm, greater than or equal to 50 μm and less than or equal to 90 μm, greater than or equal to 60 μm and less than or equal to 90 μm, greater than or equal to 75 μm and less than or equal to 90 μm, greater than 0 μm and less than or equal to 75 μm, greater than or equal to 10 μm and less than or equal to 75 μm, greater than or equal to 25 μm and less than or equal to 75 μm, greater than or equal to 40 μm and less than or equal to 75 μm, greater than or equal to 50 μm and less than or equal to 75 μm, greater than or equal to 60 μm and less than or equal to 75 μm, greater than 0 μm and less than or equal to 60 μm, greater than or equal to 10 μm and less than or equal to 60 μm, greater than or equal to 25 μm and less than or equal to 60 μm, greater than or equal to 40 μm and less than or equal to 60 μm, greater than or equal to 50 μm and less than or equal to 60 μm, greater than 0 μm and less than or equal to 50 μm, greater than or equal to 10 μm and less than or equal to 50 μm, greater than or equal to 25 μm and less than or equal to 50 μm, greater than or equal to 40 μm and less than or equal to 50 μm, greater than 0 μm and less than or equal to 40 μm, greater than or equal to 10 μm and less than or equal to 40 μm, greater than or equal to 25 μm and less than or equal to 40 μm, greater than 0 μm and less than or equal to 25 μm, greater than or equal to 10 μm and less than or equal to 25 μm, greater than 0 μm and less than or equal to 10 μm, and all ranges and subranges there between.

Lithium ions may, in embodiments, be present in the second electrode 410 at depths greater than or equal to 0 μm and less than or equal to 100 μm, such as greater than or equal to 20 μm and less than or equal to 100 μm, greater than or equal to 40 μm and less than or equal to 100 μm, greater than or equal to 50 μm and less than or equal to 100 um, greater than or equal to 60 μm and less than or equal to 100 μm, greater than or equal to 80 μm and less than or equal to 100 μm, greater than or equal to 0 μm and less than or equal to 80 μm, greater than or equal to 20 μm and less than or equal to 80 μm, greater than or equal to 40 μm and less than or equal to 80 μm, greater than or equal to 50 μm and less than or equal to 80 μm, greater than or equal to 60 μm and less than or equal to 80 μm, greater than or equal to 0 μm and less than or equal to 60 μm, greater than or equal to 20 μm and less than or equal to 60 μm, greater than or equal to 40 μm and less than or equal to 60 μm, greater than or equal to 50 μm and less than or equal to 60 μm, greater than or equal to 0 μm and less than or equal to 50 μm, greater than or equal to 20 μm and less than or equal to 50 μm, greater than or equal to 40 μm and less than or equal to 50 μm, greater than or equal to 0 μm and less than or equal to 40 μm, greater than or equal to 20 μm and less than or equal to 40 μm, or greater than or equal to 0 μm and less than or equal to 20 μm, and all ranges and subranges there between.

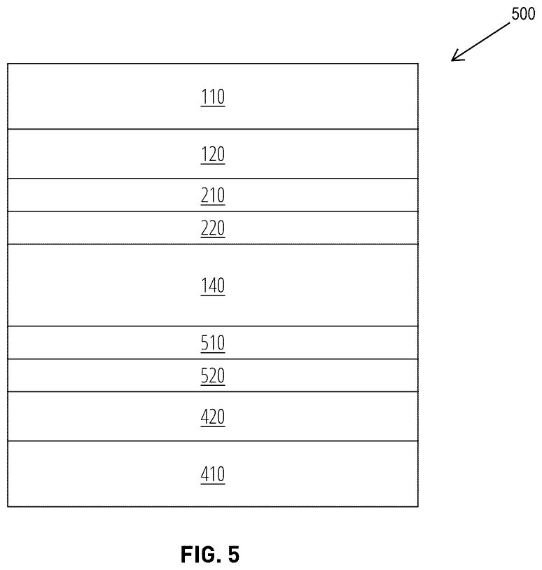

With reference now to FIG. 5, a cross-section view of a symmetric solid-state cell 500 according to embodiments disclosed and described herein is provided. The symmetric solid-state cell 500 includes an anode 110 that is configured to contain lithium when the symmetric solid-state cell 400 is in a charged state. Adjacent to the anode 110 is a magnesium layer 120. It should be understood that the magnesium layer 120 may be physically or electrically connected to the anode 110 such that lithium ions can transition from the anode 110 to the magnesium layer 120. This magnesium layer 120 can promote increased lithium diffusion and improve the intercalation/extraction cycling life of the symmetric solid-state cell 500. A first metal layer 210 is positioned adjacent to the magnesium layer 120. It should be understood that the first metal layer 210 may be physically or electrically connected to the magnesium layer 120 such that lithium ions can transition from the magnesium layer 120 to the first metal layer 210. A second metal layer 220 is positioned adjacent to the first metal layer 210. It should be understood that the second metal layer 220 may be physically or electrically connected to the first metal layer 210 such that lithium ions can transition from the first metal layer 210 to the second metal layer 220. A first additional metal layer 510 is positioned adjacent to the solid electrolyte 140. It should be understood that the first additional metal layer 510 may be physically or electrically connected to the solid electrolyte 140 such that lithium ions can transition from the solid electrolyte 140 to the first additional metal layer 510. A second additional metal layer 520 is positioned adjacent to the first additional metal layer 510. It should be understood that the second additional metal layer 520 may be physically or electrically connected to the first additional metal layer 510 such that lithium ions can transition from the first additional metal layer 510 to the second additional metal layer 520. A second magnesium layer 420 is adjacent to the second additional metal layer 520 and physically or electrically connected to the second additional metal layer 520 such that lithium ions can transition from the second additional metal layer 520 to the second magnesium layer 420. A second electrode 410 is positioned adjacent to the second magnesium layer 420 and is physically or chemically connected to the second magnesium layer 420 such that lithium ions can transition from the second magnesium layer 420 to the second electrode 410.

The anode 110, magnesium layer 120, first metal layer 210, second metal layer 220, solid electrolyte 140, second magnesium layer 420, and second electrode 410 may, in embodiments, individually be the same as those described above with reference to FIG. 1 to FIG. 4.

The first additional metal layer 510 and second additional metal layer 520 are, in embodiments individually selected from the group consisting of tin, silver, gold, platinum, aluminum, zinc, germanium, indium, gallium, antimony, bismuth, sodium, boron, and silicon. In embodiments, the first additional metal layer 510 and second additional metal layer 520 are individually selected from silver, gold, or tin. By placing at least one lithophilic metal layer between the second magnesium layer 420 and the solid electrolyte 140, the negative effects caused by directly depositing magnesium on the solid electrolyte 140 can be avoided. Moreover, the first additional metal layer 510 and second additional metal layer 520 selected from the metals disclosed hereinabove have high lithium diffusivity and can adequately regulate lithium deposition. It is believed that synergistic effects of combining a second magnesium layer 420, first additional metal layer 510, and second additional metal layer 520 between the second electrode 410 and the solid electrolyte 140 as described herein improve the contact and stability of the second electrode 410 and solid electrolyte 140 interface and can improve cell performance. According to embodiments, the first additional metal layer 510 and second additional metal layer 520 may individually be applied to the solid electrolyte 140 or first additional metal layer 510, respectively, by sputtering, chemical vapor deposition, physical vapor deposition, plating (such as electroplating and electroless plating), coating (such as spin coating or dip coating), or similar methods.

The thickness of the first additional metal layer 510 and second additional metal layer 520 are, according to embodiments, individually greater than or equal to 10 nm and less than or equal to 10,000 nm, such as greater than or equal to 50 nm and less than or equal to 10,000 nm, greater than or equal to 500 nm and less than or equal to 10,000 nm, greater than or equal to 1000 nm and less than or equal to 10,000 nm, greater than or equal to 1500 nm and less than or equal to 10,000 nm, greater than or equal to 2000 nm and less than or equal to 10,000 nm, greater than or equal to 3000 nm and less than or equal to 10,000 nm, greater than or equal to 4000 nm and less than or equal to 10,000 nm, greater than or equal to 5000 nm and less than or equal to 10,000 nm, greater than or equal to 6000 nm and less than or equal to 10,000 nm, greater than or equal to 7000 nm and less than or equal to 10,000 nm, greater than or equal to 8000 nm and less than or equal to 10,000 nm, greater than or equal to 9000 nm and less than or equal to 10,000 nm, greater than or equal to 10 nm and less than or equal to 9000 nm, greater than or equal to 50 nm and less than or equal to 9000 nm, greater than or equal to 500 nm and less than or equal to 9000 nm, greater than or equal to 1000 nm and less than or equal to 9000 nm, greater than or equal to 1500 nm and less than or equal to 9000 nm, greater than or equal to 2000 nm and less than or equal to 9000 nm, greater than or equal to 3000 nm and less than or equal to 9000 nm, greater than or equal to 4000 nm and less than or equal to 9000 nm, greater than or equal to 5000 nm and less than or equal to 9000 nm, greater than or equal to 6000 nm and less than or equal to 9000 nm, greater than or equal to 7000 nm and less than or equal to 9000 nm, greater than or equal to 8000 nm and less than or equal to 9000 nm, greater than or equal to 10 nm and less than or equal to 8000 nm, greater than or equal to 50 nm and less than or equal to 8000 nm, greater than or equal to 500 nm and less than or equal to 8000 nm, greater than or equal to 1000 nm and less than or equal to 8000 nm, greater than or equal to 1500 nm and less than or equal to 8000 nm, greater than or equal to 2000 nm and less than or equal to 8000 nm, greater than or equal to 3000 nm and less than or equal to 8000 nm, greater than or equal to 4000 nm and less than or equal to 8000 nm, greater than or equal to 5000 nm and less than or equal to 8000 nm, greater than or equal to 6000 nm and less than or equal to 8000 nm, greater than or equal to 7000 nm and less than or equal to 8000 nm, greater than or equal to 10 nm and less than or equal to 7000 nm, greater than or equal to 50 nm and less than or equal to 7000 nm, greater than or equal to 500 nm and less than or equal to 7000 nm, greater than or equal to 1000 nm and less than or equal to 7000 nm, greater than or equal to 1500 nm and less than or equal to 7000 nm, greater than or equal to 2000 nm and less than or equal to 7000 nm, greater than or equal to 3000 nm and less than or equal to 7000 nm, greater than or equal to 4000 nm and less than or equal to 7000 nm, greater than or equal to 5000 nm and less than or equal to 7000 nm, greater than or equal to 6000 nm and less than or equal to 7000 nm, greater than or equal to 10 nm and less than or equal to 6000 nm, greater than or equal to 50 nm and less than or equal to 6000 nm, greater than or equal to 500 nm and less than or equal to 6000 nm, greater than or equal to 1000 nm and less than or equal to 6000 nm, greater than or equal to 1500 nm and less than or equal to 6000 nm, greater than or equal to 2000 nm and less than or equal to 6000 nm, greater than or equal to 3000 nm and less than or equal to 6000 nm, greater than or equal to 4000 nm and less than or equal to 6000 nm, greater than or equal to 5000 nm and less than or equal to 6000 nm, greater than or equal to 10 nm and less than or equal to 5000 nm, greater than or equal to 50 nm and less than or equal to 5000 nm, greater than or equal to 500 nm and less than or equal to 5000 nm, greater than or equal to 1000 nm and less than or equal to 5000 nm, greater than or equal to 1500 nm and less than or equal to 5000 nm, greater than or equal to 2000 nm and less than or equal to 5000 nm, greater than or equal to 3000 nm and less than or equal to 5000 nm, greater than or equal to 4000 nm and less than or equal to 5000 nm, greater than or equal to 10 nm and less than or equal to 4000 nm, greater than or equal to 50 nm and less than or equal to 4000 nm, greater than or equal to 500 nm and less than or equal to 4000 nm, greater than or equal to 1000 nm and less than or equal to 4000 nm, greater than or equal to 1500 nm and less than or equal to 4000 nm, greater than or equal to 2000 nm and less than or equal to 4000 nm, greater than or equal to 3000 nm and less than or equal to 4000 nm, greater than or equal to 10 nm and less than or equal to 3000 nm, greater than or equal to 50 nm and less than or equal to 3000 nm, greater than or equal to 500 nm and less than or equal to 3000 nm, greater than or equal to 1000 nm and less than or equal to 3000 nm, greater than or equal to 1500 nm and less than or equal to 3000 nm, greater than or equal to 2000 nm and less than or equal to 3000 nm, greater than or equal to 10 nm and less than or equal to 2000 nm, greater than or equal to 50 nm and less than or equal to 2000 nm, greater than or equal to 500 nm and less than or equal to 2000 nm, greater than or equal to 1000 nm and less than or equal to 2000 nm, greater than or equal to 1500 nm and less than or equal to 2000 nm, greater than or equal to 10 nm and less than or equal to 1500 nm, greater than or equal to 50 nm and less than or equal to 1500 nm, greater than or equal to 500 nm and less than or equal to 1500 nm, greater than or equal to 1000 nm and less than or equal to 1500 nm, greater than or equal to 10 nm and less than or equal to 1000 nm, greater than or equal to 50 nm and less than or equal to 1000 nm, greater than or equal to 500 nm and less than or equal to 1000 nm, greater than or equal to 10 nm and less than or equal to 500 nm, greater than or equal to 50 nm and less than or equal to 500 nm, or greater than or equal to 10 nm and less than or equal to 50 nm, and all ranges and subranges there between.

A first aspect includes a solid-state battery comprising: a solid electrolyte; an anode configured to contain lithium when the solid-state battery is in a charged state; a magnesium layer positioned adjacent to the anode and between the anode and the solid electrolyte; and at least one metal layer positioned adjacent to the magnesium layer and between the magnesium layer and the solid electrolyte.

A second aspect includes solid-state battery of the first aspect, wherein the at least one metal layer comprises tin, silver, gold, platinum, aluminum, zinc, germanium, indium, gallium, antimony, bismuth, sodium, boron, silicon, or any combination thereof.

A third aspect includes a solid-state battery of any of the preceding aspects, wherein the at least one metal layer comprises silver, gold, tin, or any combination thereof.

A fourth aspect includes a solid-state battery of any of the preceding aspects, wherein the at least one metal layer has a thickness that is greater than or equal to 10 nm and less than or equal to 10000 nm.

A fifth aspect includes a solid-state battery of the first aspect, wherein the at least one metal layer comprises a first metal layer and a second metal layer, and the first metal layer is adjacent to the magnesium layer and the second metal layer is adjacent to the solid electrolyte.

A sixth aspect includes a solid-state battery of the fifth aspect, wherein the first metal layer comprises tin, silver, gold, platinum, aluminum, zinc, germanium, indium, gallium, antimony, bismuth, sodium, boron, silicon, or any combination thereof, the second metal layer comprises tin, silver, gold, platinum, aluminum, zinc, germanium, indium, gallium, antimony, bismuth, sodium, boron, silicon, or any combination thereof, and the first metal layer comprises a different metal than the second metal layer.

A seventh aspect includes a solid-state battery of the fifth or sixth aspect, wherein the first metal layer comprises silver, and the second metal layer comprises tin.

An eighth aspect includes a solid-state battery of any one of the fifth to seventh aspects, wherein the first metal layer has a thickness that is greater than or equal to 10 nm and less than or equal to 10000 nm.

A ninth aspect includes a solid-state battery of any one of the fifth to eighth aspects, wherein the second metal layer has a thickness that is greater than or equal to 10 nm and less than or equal to 10000 nm.

A tenth aspect includes a solid-state battery of any one of the preceding aspects, wherein the solid-state battery comprises a second electrode.

An eleventh aspect includes a solid-state battery of the tenth aspect, wherein the second electrode is adjacent to the solid electrolyte, and the magnesium layer and the at least one metal layer are positioned on an opposite side of the solid electrolyte than the second electrode.

A twelfth aspect includes a solid-state battery of the tenth or eleventh aspects, wherein the second electrode comprises lithium cobalt oxide, lithium manganese oxide, lithium iron phosphate, lithium nickel manganese cobalt oxide, or any combination thereof.

A thirteenth aspect includes a solid-state battery of any one of the tenth to twelfth aspects, wherein the second electrode comprises lithium cobalt oxide.

A fourteenth aspect includes a solid-state battery of the tenth aspect, further comprising: a second magnesium layer positioned adjacent to the second electrode and between the second electrode and the solid electrolyte; and at least one additional metal layer positioned adjacent to the second magnesium layer and between the second magnesium layer and the solid electrolyte.

A fifteenth aspect includes a solid-state battery of the fourteenth aspect, wherein the at least one additional metal layer comprises tin, silver, gold, platinum, aluminum, zinc, germanium, indium, gallium, antimony, bismuth, sodium, boron, silicon, or any combination thereof.

A sixteenth aspect includes a solid-state battery of the fourteenth or fifteenth aspects, wherein the at least one additional metal layer comprises silver, gold, tin, or any combination thereof.

A seventeenth aspect includes a solid-state battery of any one of the fourteenth to sixteenth aspects, wherein the at least one additional metal layer has a thickness that is greater than or equal to 10 nm and less than or equal to 10000 nm.

An eighteenth aspect includes a solid-state battery of the fourteenth aspect, wherein the at least one additional metal layer comprises a first additional metal layer and a second additional metal layer.

A nineteenth aspect includes a solid-state battery of the eighteenth aspect, wherein the first additional metal layer comprises tin, silver, gold, platinum, aluminum, zinc, germanium, indium, gallium, antimony, bismuth, sodium, boron, silicon, or any combination thereof, and the second additional metal layer comprises tin, silver, gold, platinum, aluminum, zinc, germanium, indium, gallium, antimony, bismuth, sodium, boron, silicon, or any combination thereof.

A twentieth aspect includes a solid-state battery of the eighteenth or nineteenth aspects, wherein the first additional metal layer has a thickness that is greater than or equal to 10 nm and less than or equal to 10000 nm, and the second additional metal layer has a thickness that is greater than or equal to 10 nm and less than or equal to 10000 nm.

A twenty-first aspect includes a solid-state battery of any one of claims 18 to 20, wherein the second magnesium layer has a thickness that is greater than or equal to 15 nm and less than or equal to 20000 nm.

A twenty-second aspect includes a solid-state battery of any of the preceding aspects, wherein the magnesium layer has a thickness that is greater than or equal to 15 nm and less than or equal to 20000 nm.

A twenty-third aspect includes a solid-state battery of any of the preceding aspects, wherein lithium is present in the anode at depths greater than or equal to 0 μm and less than or equal to 100 μm.

A twenty-fourth aspect includes a solid-state battery of any of the preceding aspects, wherein the solid electrolyte is a garnet-type electrolyte.

A twenty-fifth aspect includes a solid-state battery of any of the preceding aspects, wherein the solid electrolyte is lithium lanthanum zirconium oxide.

A twenty-sixth aspect includes a consumer electronic product, comprising: a housing having a front surface, a back surface and side surfaces; electrical components at least partially within the housing, the electrical components including at least a controller, a memory, and a display; and a solid-state battery of any of the preceding aspects within the housing.

A twenty-seventh aspect includes a method for making a solid-state battery of any one of the preceding aspects comprising, in any order: providing a solid electrolyte; depositing the at least one metal layer onto the solid electrolyte; depositing the magnesium layer onto the at least one metal layer; and applying the anode to the magnesium layer.

A twenty-eighth aspect includes a method of the twenty-seventh aspect wherein the at least one metal layer and the magnesium layer are deposited by sputtering, chemical vapor deposition, physical vapor deposition, plating, coating, or combinations thereof.

A twenty-ninth aspect includes a method of the twenty-seventh or twenty-eighth aspects wherein the anode is applied by attaching a lithium-containing foil to the magnesium layer.

A thirtieth aspect includes a method of any one of the twenty seventh to twenty ninth aspects, wherein the at least one metal layer comprises a first metal layer and a second metal layer, and the method comprises, in any order: depositing the second metal layer onto the solid electrolyte; depositing the first metal layer onto the second metal layer; and depositing the magnesium layer onto the first metal layer.

A thirty-first aspect includes a method of any one of the twenty-seventh to thirtieth aspects, further comprising depositing a second electrode onto the solid electrolyte.

A thirty-second aspect includes a method of the thirty-first aspect, wherein the second electrode is deposited by sputtering, chemical vapor deposition, physical vapor deposition, plating, coating, or combinations thereof.

A thirty-third aspect includes a method of any one of the twenty-seventh to thirtieth aspects further comprising: depositing at least one additional metal layer onto the solid electrolyte; depositing a second magnesium layer onto the at least one additional metal layer; and applying a second electrode to the second magnesium layer.

A thirty-fourth aspect includes a method of the thirty-third aspect wherein the at least one additional metal layer and the magnesium layer are deposited by sputtering, chemical vapor deposition, physical vapor deposition, plating, coating, or combinations thereof.

A thirty-fifth aspect includes a method of the thirty-third of thirty-fourth aspect, wherein the second electrode is applied by attaching a lithium-containing foil to the magnesium layer.

### EXAMPLES

Cubic phase Li_{6.5}La₃Zr_{1.4}Ta_{0.5}O₁₂ (LLZTO) was synthesized from starting powders of LiOH•H₂O (AR), La₂O₃ (99.99%), ZrO₂ (AR), Ta₂O₅ (99.99%) with stoichiometry ratio. 2 wt. % excess of LiOH•H₂O added to compensate the lithium loss during the sintering process. Traces of moisture and adsorbed CO₂ were removed from La₂O₃ by heat treatment at 900° C. for 12 h. Raw materials were mixed via a wet grinding process in which yttrium-stabilized zirconium oxide (YSZ) balls and isopropanol (IPA) were used as the milling media. The mixture was dried and calcined at 950° C. for 6 h in an alumina crucible to obtain pure cubic garnet phase powder. These powders were pressed into Φ 16 mm green pellets and sintered at 1230° C. for 1 h covered with LLZTO powder with 15 wt. % Li excess in platinum crucibles. This tantalum-doped lithium lanthanum zirconium oxide was used as the solid electrolyte (SE) in examples.

Interlayers, such as the magnesium layers and metal layers, were deposited on the SE surface through sputtering or plating or coating. Subsequently, 20 μm thick Li foils with release film, such as PET film or silicone-coated paper acting as compliant layer, were then placed on top the coated SE in sequence. Attachment of Li foil on the SE pellet was conducted by pressing or molten Li method. Afterwards the released film was removed, and the as-prepared samples were heated at approximately 80° C. to 170° C. for approximately 5 to 30 minutes to promote the contact between Li foil and interlayer. The obtained samples were then ready for cell assembly.

To for symmetric lithium cells, acid treatment was performed to clean the SE surface by immersing the pellets into 1M HCl solution (in distilled water) at room temperature for approximately 3 to 10 minutes. The obtained pellets were rinsed with ethanol and transferred to glovebox for the abovementioned interlayer deposition. Both sides of the pellets were then attached with 20 μm fresh Li foils. The 2025-type Li|SE|Li symmetric cells were then assembled in glove box. The Ni foams were placed on top of the Li foils to ensure the contact within the coin cell, and to serve as a buffer to diminish the risk of the crack of the brittle pellet during coin cell sealing. The applied pressure to seal the coin cell was about 50 MPa.

To form full cells with lithium cobalt oxide (LCO) as cathode, the pellet surface cleaning and Li foil attachment procedures were in same way as the abovementioned symmetric cell. At first, either side of the pellet was attached with 20 μm fresh Li foil. Commercially available LCO was employed as a cathode and Al foil was used as a current collector. Lithium bis(fluorosulfonyl) imide (LiFSI) salt mixed with sulfonate solvent was used as the catholyte. The catholyte solution with about 5 to 20 wt % amount relative to the cathode was infiltrated into the cathode. The infiltrated cathode was then placed on the cathode side of the Li foil attached garnet pellet. The as-prepared samples were at last assembled in CR2025 coin cells.

### Example 1

First, a 70 nm-thick Ag layer and 500 nm-thick Mg layer were sequential deposited on a surface treated garnet pellet via ion sputtering. The garnet sample was with a thickness of 0.65 μm and a diameter of 14 mm. The fresh Li foils with a thickness of 0.02 mm and a diameter of 12 mm were then placed on both sides of the coated garnet. Cold Isostatic Pressing was applied with a pressure of 250 MPa and a duration of 5 minutes to ensure the attachment between Li foils and the pellet. The Li attached pellet were heat treated at 120° C. for 10 minutes to promote the contact. The Ni foam with a thickness of 1 mm and a diameter of 12 mm was placed on top of the Li foil to ensure the contact within the coin cell, and to serve as a buffer to diminish the risk of the crack of the brittle pellet during coin cell sealing. The Li|Mg|Ag|SE|Ag|Mg|Li symmetric cell was then assembled. The interfacial contact between Li anode and garnet was indicated by the interfacial resistance obtained from EIS test. The critical current density was measured at 25° C. by galvanostatic cycling from 0.1 to 3.0 mA/cm² with increasing current at intervals of 0.1 mA/cm², cycling twice under each current interval and the duration of each cycling step was 0.5 h.

### Comparative Example 1

Cells were prepared in the same manner as that in Example 1 except no Ag layer and Mg layer were deposited on the garnet. The cell configuration was Li|SE|Li.

### Comparative Example 2

Cells were prepared in the same manner as that in Example 1 except only Ag layer was deposited on the garnet. The cell configuration was Li|Ag|SE|Ag|Li.

### Comparative Example 3

Cells were prepared in the same manner as that in Example 1 except only Mg layer was deposited on the garnet. The cell configuration was Li|Mg|SE|Mg|Li.

### Comparative Example 4

Cells were prepared in the same manner as that in Example 1 except the deposition sequence of Ag, Mg layer on the garnet was different. The cell configuration was Li|Ag|Mg|SE|Mg|Ag|Li.

### Example 2

Preparation procedures of interlayer deposition and Li foil attachment onto the garnet were prepared in the same way as that in Example 1, and either side of the garnet was attached with Li foil. The cell configuration was LCO|SE|Ag|Mg|Li, which was different from that in Example 1. The charging critical current density was measured at 25° C. by galvanostatic cycling from 0.3 to 1.5 mA/cm² at 3 mAh/cm² with increasing charging current density. The charge and discharge current density were at 0.3 mA/cm² for the first 2 cycle. The charge current density was then cycled three times at 0.6 mA/cm², 1.0 mA/cm² and 1.5 mA/cm², the current density is constant at 0.6 mA/cm² with a cutoff voltage of 3V. The cells were then cycling under 1.5 mA/cm² charge rate and 0.6 mA/cm² discharge rate to evaluate the cycling performance.

### Comparative Example 5

Cells were prepared the same as that in Example 2 except only Ag layer was deposited on the garnet. The cell configuration was LCO|SE|Ag|Li.

### Example 3

Cells were prepared the same as that in Example 2 except 70 nm-thick Ag layer was changed to 200 nm-thick Au layer. The cell configuration was LCO|SE|Au|Mg|Li.

### Comparative Example 6

Cells were prepared the same as that in Example 3 except only Au layer was deposited on the garnet. The cell configuration was LCO|SE|Au|Li.

### Example 4

Cells were prepared the same as that in Example 2 except an extra 200 nm-thick Sn layer deposited in between the garnet and Ag layer. The cell configuration was LCO|SE|Sn|Ag|Mg|Li.

### Electrochemical Measurements and Discussion

Impedance (EIS) measurements were performed by AC impedance analysis (Solartron 1260A) with the frequency range of 0.1 Hz to 1 MHz. The galvanostatic cycling and plating experiments of Li symmetric cells and critical current density experiments of LCO| garnet |Li full cells were tested by battery test system (LAND, CT2001A). Symmetric cell and full cell testing were conducted at 25° C.

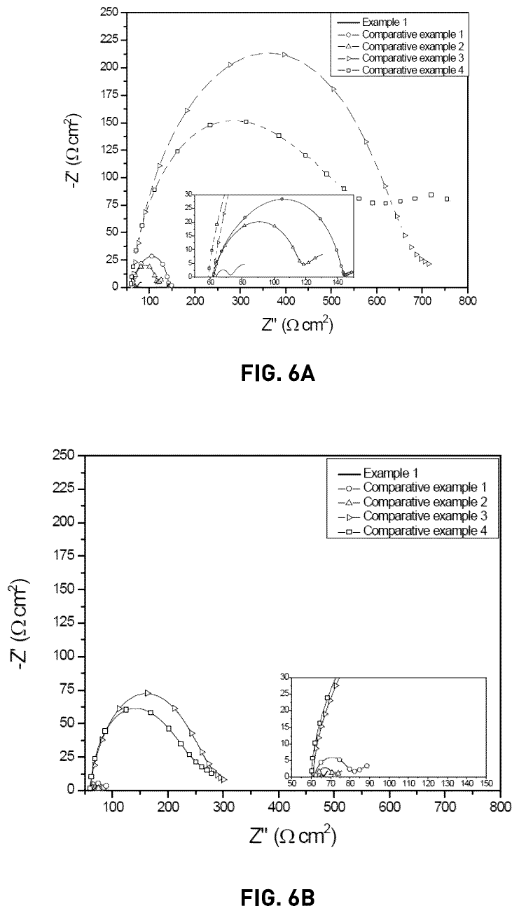

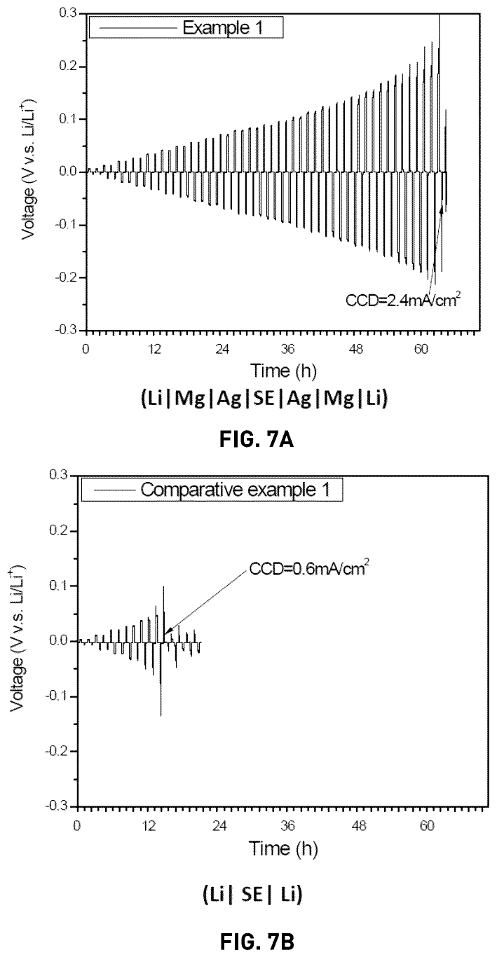

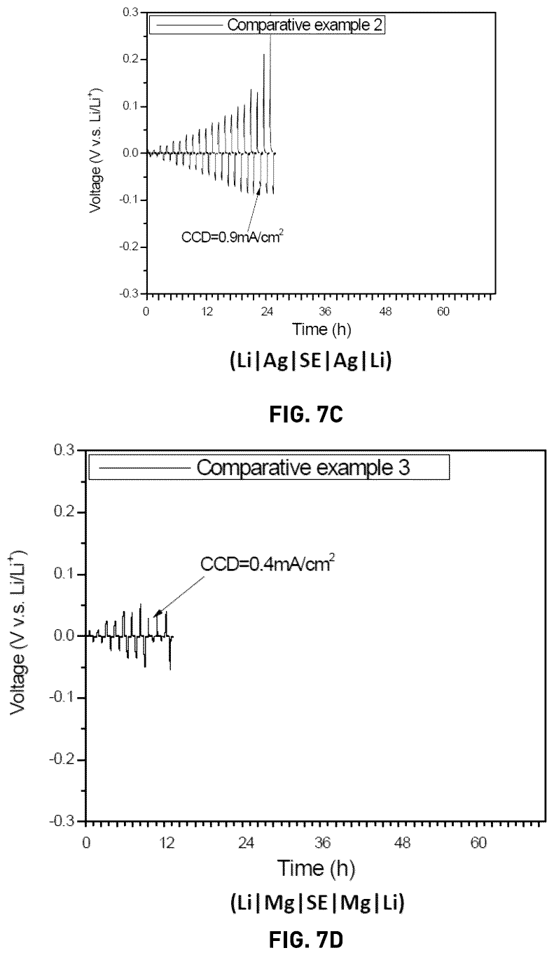

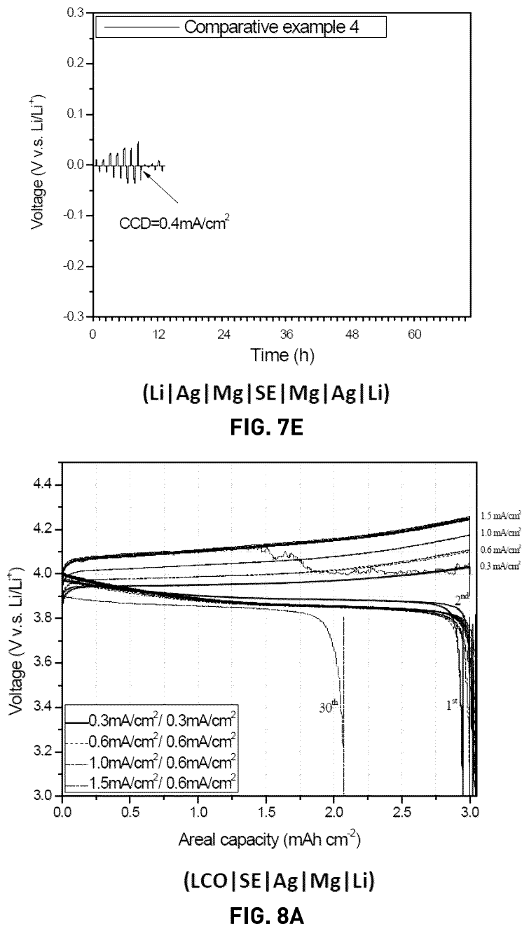

In Example 1, the symmetric cell with specific arrangement of magnesium containing multi-layer composite interlayer, SE|Ag|Mg|Li, as illustrated in FIG. 1 exhibited a smallest Li/garnet interfacial resistance with a value of less than 0.2 Ω cm² and a highest CCD with a number of 2.4 mA/cm², compared with that of the bare SE counterpart (Comparative example 1), SE|Ag counterpart (Comparative example 2), SE|Mg counterpart (Comparative example 3), SE|Mg|Ag counterpart (Comparative example 4) as presented in Table 1, which summarized the interfacial resistance and CCD data of the tested samples as shown in FIG. 6A to FIG. 6B and FIG. 7A to FIG. 7E.

As displayed in FIG. 6A and FIG. 6B, the IR of all samples after moderate heat treatment was mitigated, which was likely attributed to the thermal promoted chemical diffusion of the lithiophilic layer with the Li foil. As expected, compared with the bare SE (Comparative example 1 shown in FIG. 7B), with the adoption of lithiophilic Ag layer (Comparative example 2 shown in FIG. 7C), the Li/garnet interfacial resistance and CCD was mitigated from 10.6 (2 cm² to 4.3 Ωcm² and 0.6 mA/cm² to 0.9 mA/cm². In addition, by applying a Mg adjacent to (on top of) the Ag layer (Example 1 shown in FIG. 7A), the interfacial resistance and CCD was significantly improved to a value of 0.2 Ωcm² and 2.4 mA/cm². However, In Comparative example 3 and Comparative example 4 (FIG. 7D and FIG. 7E, respectively), by directly depositing the Mg layer onto the garnet surface, the cell performance was drastically deteriorated, with a substantially larger IR, 114 Ωcm² and 99.5 Ωcm², and lower CCD, 0.4 and 0.4 mA/cm². This could possibly indicate side reaction might took place between the deposited Mg and garnet sample.

TABLE 1

| | Bare SE | SE\|Ag | SE\|Mg | SE\|Ag\|Mg | SE\|Mg \|Ag |
|---|---|---|---|---|---|
| IR-As prepared | 40.5 | 28.7 | 304.4 | 4.4 | 263.2 |
| [Ω cm²] | | | | | |
| IR-heat treated | 10.6 | 4.3 | 114 | 0.19 | 99.5 |
| [Ω cm²] | | | | | |
| CCD [mA/cm²] | 0.6 | 0.9 | 0.4 | 2.4 | 0.4 |

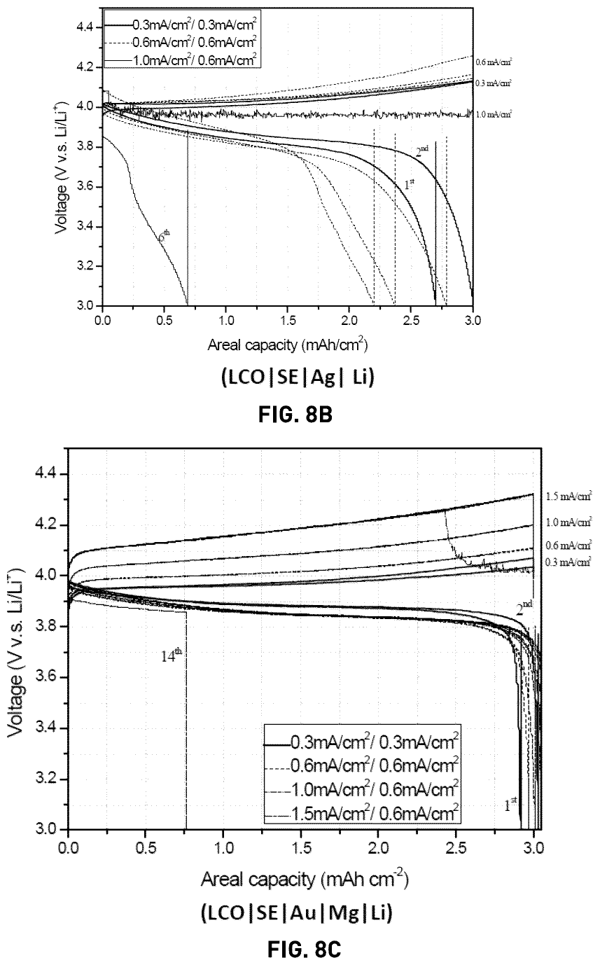

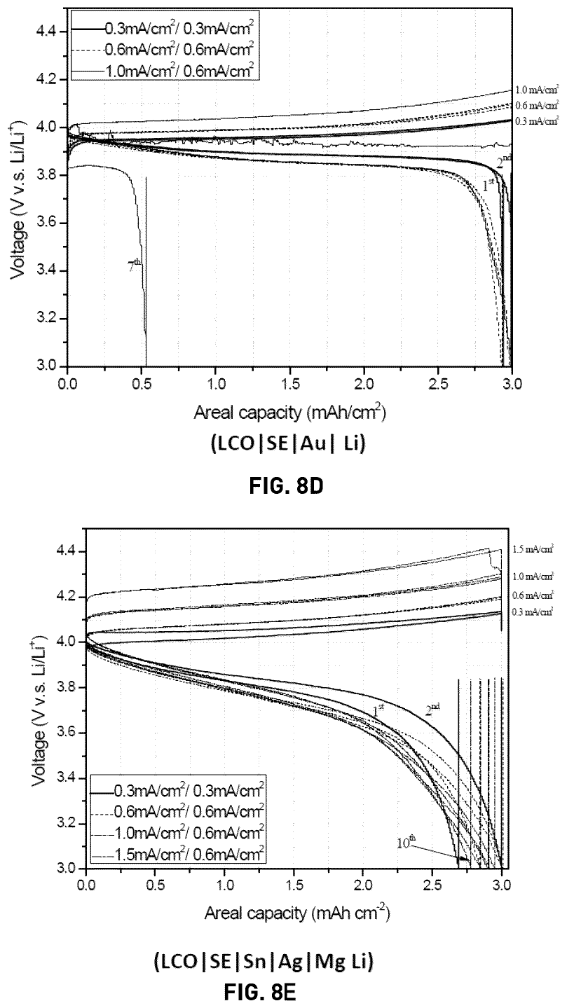

In Example 2, a full cell with a specific arrangement of magnesium containing multi-layer composite interlayer, SE|Ag|Mg, delivered an improved charging CCD with a number of 1.5 mA/cm² cycling at a practical capacity of 3 mAh/cm² and could be cycled over 30 times as displayed in FIG. 8A. As a comparison, without the Mg layer, the SE|Ag counterpart (Comparative example 5) delivered a reduced CCD with a value of 0.6 mA/cm² cycling at a practical capacity of 3 mAh/cm² and prematurely shorted at 6th cycle as displayed in FIG. 8B.

In Example 3, a full cell with a specific arrangement of magnesium containing multi-layer composite interlayer, SE|Au|Mg, delivered a higher charging CCD with a number of 1.5 mA/cm² cycling at a practical capacity of 3 mAh/cm² (Shown in FIG. 8C) than the SE|Au counterpart (Comparative example 6), which shorted at 1 mA/cm², as shown in FIG. 8D. With an Mg layer attached adjacent to a metal layer as illustrated in FIG. 1, both Example 2 and Example 3 exhibited better performance than the counterpart that without an Mg layer. This was consistent with Example 1, supporting the effectiveness of the magnesium containing multi-layer composite interlayer with specific arrangement.

With a second metal layer as shown in in FIG. 2, the interlayer configuration of Example 4, SE|Sn|Ag|Mg|Li, exhibited a similar performance as that of the single metal layer counterpart. For instance, FIG. 8E shows that the LCO|SE|Sn|Ag|Mg|Li full cell delivered a charging CCD of 1.5 mA/cm² cycling at a practical capacity of 3 mAh/cm².

What is claimed is:

1. A solid-state battery comprising:
a solid electrolyte;
an anode configured to contain lithium when the solid-state battery is in a charged state;
a magnesium layer positioned adjacent to the anode and between the anode and the solid electrolyte; and
at least one metal layer positioned adjacent to the magnesium layer and between the magnesium layer and the solid electrolyte.

2. The solid-state battery of claim 1, wherein the at least one metal layer comprises tin, silver, gold, platinum, aluminum, zinc, germanium, indium, gallium, antimony, bismuth, sodium, boron, silicon, or any combination thereof.

3. The solid-state battery of claim 1, wherein the at least one metal layer comprises silver, gold, tin, or any combination thereof.

4. The solid-state battery of claim 1, wherein the at least one metal layer comprises a first metal layer and a second metal layer, and the first metal layer is adjacent to the magnesium layer and the second metal layer is adjacent to the solid electrolyte.

5. The solid-state battery of claim 4, wherein
the first metal layer comprises tin, silver, gold, platinum, aluminum, zinc, germanium, indium, gallium, antimony, bismuth, sodium, boron, silicon, or any combination thereof,
the second metal layer comprises tin, silver, gold, platinum, aluminum, zinc, germanium, indium, gallium, antimony, bismuth, sodium, boron, silicon, or any combination thereof, and
the first metal layer comprises a different metal than the second metal layer.

6. The solid-state battery of claim 4, wherein
the first metal layer comprises silver, and
the second metal layer comprises tin.

7. The solid-state battery of claim 1, wherein the solid-state battery comprises a second electrode.

8. The solid-state battery of claim 7, wherein
the second electrode is adjacent to the solid electrolyte, and
the magnesium layer and the at least one metal layer are positioned on an opposite side of the solid electrolyte than the second electrode.

9. The solid-state battery of claim 7, wherein the second electrode comprises lithium cobalt oxide, lithium manganese oxide, lithium iron phosphate, lithium nickel manganese cobalt oxide, or any combination thereof.

10. The solid-state battery of claim 7, wherein the second electrode comprises lithium cobalt oxide.

11. The solid-state battery of claim 7, further comprising:
a second magnesium layer positioned adjacent to the second electrode and between the second electrode and the solid electrolyte; and
at least one additional metal layer positioned adjacent to the second magnesium layer and between the second magnesium layer and the solid electrolyte.

12. The solid-state battery of claim 11, wherein the at least one additional metal layer comprises tin, silver, gold, platinum, aluminum, zinc, germanium, indium, gallium, antimony, bismuth, sodium, boron, silicon, or any combination thereof.

13. The solid-state battery of claim 11, wherein the at least one additional metal layer comprises silver, gold, tin, or any combination thereof.

14. The solid-state battery of claim 11, wherein the at least one additional metal layer comprises a first additional metal layer and a second additional metal layer.

15. The solid-state battery of claim 14, wherein
the first additional metal layer comprises tin, silver, gold, platinum, aluminum, zinc, germanium, indium, gallium, antimony, bismuth, sodium, boron, silicon, or any combination thereof, and
the second additional metal layer comprises tin, silver, gold, platinum, aluminum, zinc, germanium, indium, gallium, antimony, bismuth, sodium, boron, silicon, or any combination thereof.

16. The solid-state battery of claim 1, wherein lithium is present in the anode at depths greater than or equal to 0 μm and less than or equal to 100 μm.

17. The solid-state battery of claim 1, wherein the solid electrolyte is a garnet-type electrolyte.

18. The solid-state battery of claim 1, wherein the solid electrolyte is lithium lanthanum zirconium oxide.

19. A consumer electronic product, comprising:
a housing having a front surface, a back surface and side surfaces;
electrical components at least partially within the housing, the electrical components including at least a controller, a memory, and a display; and
the solid-state battery of claim 1 within the housing.

20. A method for making the solid-state battery of claim 1, comprising, in any order:
providing a solid electrolyte;
depositing the at least one metal layer onto the solid electrolyte;
depositing the magnesium layer onto the at least one metal layer; and
applying the anode to the magnesium layer.
